(19) United States
(12) Patent Application Publication
(10) Pub. No.: US 2026/0038885 A1
(43) Pub. Date: Feb. 5, 2026

(54) SOLID ELECTROLYTE COMPOSITION, SOLID ELECTROLYTE LAYER OR ELECTRODE MIXTURE, AND LITHIUM ION BATTERY

(71) Applicant: IDEMITSU KOSAN CO.,LTD., Chiyoda-ku, Tokyo (JP)

(72) Inventors: Kenji MORIYAMA, Chiyoda-ku, Tokyo (JP); Keita SEDA, Chiyoda-ku, Tokyo (JP); Akito TAKASHIMA, Chiyoda-ku, Tokyo (JP)

(73) Assignee: IDEMITSU KOSAN CO.,LTD., Chiyoda-ku, Tokyo (JP)

(21) Appl. No.: 18/995,275

(22) PCT Filed: Jul. 26, 2023
(86) PCT No.: PCT/JP2023/027348

§ 371 Date: Jan. 16, 2025

(30) Foreign Application Priority Data
Jul. 27, 2022 (JP) 2022-119981

(51) Int. Cl. H01M 10/42; H01M 4/62; H01M 10/0525; H01M 10/0562

(52) U.S. Cl. CPC H01M 10/4235; H01M 4/62; H01M 10/0525; H01M 10/0562; H01M 2300/008

(57) ABSTRACT

A solid electrolyte composition including (A) a sulfide solid electrolyte including lithium, phosphorus and sulfur, and (B) one or more compounds selected from the compounds represented by the following formulas (1) to (17).

R¹¹R¹²R¹³P (1)

(NR²¹R²²)(NR²³R²⁴)(NR²⁵R²⁶)P (2)

R³¹R³²R³³PS (3)

(NR⁴¹R⁴²)(NR⁴³R⁴⁴)(NR⁴⁵R⁴⁶)PS (4)

R⁵¹SH (5)

R⁶¹COOR⁶² (6)

R⁷¹NH₂ (7)

R⁸¹R³²R³³N (8)

R⁹¹(OA)ₙOH (9)

(R¹⁰¹O)(R¹⁰²O)(R¹⁰³O)P (10)

R¹¹¹R¹¹²R¹¹³R¹¹⁴M1 (11)

R¹²¹R¹²²R¹²³M2 (12)

R¹³¹R¹³²R¹³³M3 (13)

R¹⁴¹—C(═O)NH—R¹⁴² (14)

R¹⁵¹R¹⁵²R¹⁵³C—OH (15)

R¹⁶¹—O—R¹⁶² (16)

(SR¹⁷¹)(SR¹⁷²)(SR¹⁷³)P (17)

### TECHNICAL FIELD

The present invention relates to a solid electrolyte composition, a solid electrolyte layer or an electrode mixture, and a lithium-ion battery.

### BACKGROUND ART

Although all-solid-state lithium-ion battery is becoming more popular due to reasons such as high safety, it is difficult to ensure contacts between electrolytes or between active material and electrolyte compared with lithium-ion battery using liquid electrolyte because of the use of solid electrolyte. In particular, when solid electrolyte is compressed, a void remains and the densification is insufficient, it becomes difficult to sufficiently draw out the performance of the battery.

Although Patent Document 1 discloses a technology for obtaining a dense molded body by adding a phosphine oxide compound having a particular structure to a solid electrolyte is disclosed, there is a problem in that the ionic conductivity is greatly reduced by the addition of the phosphine oxide compound.

### RELATED ART DOCUMENTS

### Patent Documents

[Patent Document 1] JP 2020-166994 A

### SUMMARY OF THE INVENTION

An object of the present invention is to provide a solid electrolyte composition that has high dense when it is compressed and can have high ionic conductivity.

The inventors of the present invention considered that the above problems were caused by friction between the particles that constitute the solid electrolyte, and after extensive investigations, the inventors have found that the above problems can be solved by adding compound having the specific structure to the solid electrolyte, and have completed the present invention.

According to the present invention, the following solid electrolyte composition and the like are provided.
1. A solid electrolyte composition comprising
   (A) a sulfide solid electrolyte comprising lithium, phosphorus and sulfur, and
   (B) one or more compounds selected from compounds represented by the following formulas (1) to (17):

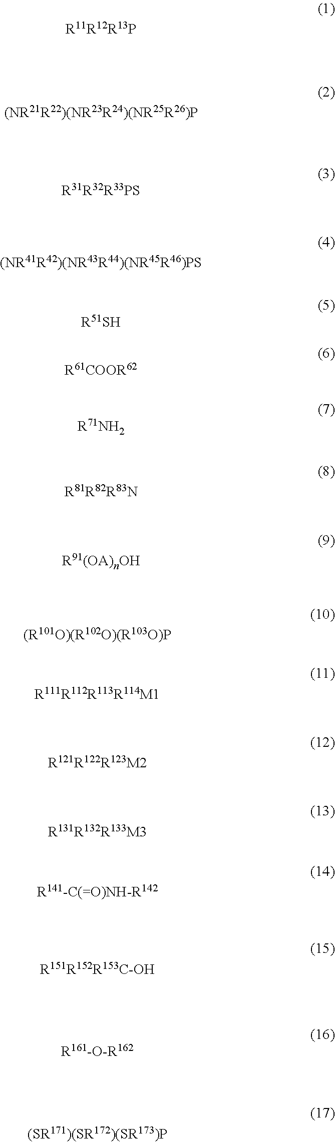

wherein in the formula (1), R¹¹ to R¹³ are independently a hydrogen atom or a substituent RA, and at least one of R¹¹ to R¹³ is the substituent RA;
   in the formula (2), R²¹ to R²⁶ are independently a hydrogen atom or a substituent RA, and at least one of R²¹ to R²⁶ is the substituent RA;
   in the formula (3), R³¹ to R³³ are independently a hydrogen atom or a substituent RA, and at least one of R³¹ to R³³ is the substituent RA;
   in the formula (4), R⁴¹ to R⁴⁶ are independently a hydrogen atom or a substituent RA, and at least one of R⁴¹ to R⁴⁶ is the substituent RA;
   in the formula (5), R⁵¹ is a substituent RA;
   in the formula (6), R⁶¹ is a substituent RA, and R⁶² is a hydrogen atom or a substituent RA;
   in the formula (7), R⁷¹ is a substituent RA;
   in the formula (8), R⁸¹ to R⁸³ are independently a hydrogen atom or a substituent RA, and at least one of R⁸¹ to R⁸³ is the substituent RA;
   in the formula (9), R⁹¹ is a substituent RA, and A is an alkylene group having 2 to 4 carbon atoms; n is 1 to 20;
   in the formula (10), R¹⁰¹ to R¹⁰³ are independently a hydrogen atom or a substituent RA, and at least one of R¹⁰¹ to R¹⁰³ is the substituent RA;
   in the formula (11), R¹¹¹ to R¹¹⁴ are independently a hydrogen atom, a substituent RA, or a group represented by —O—RA, and at least one of R¹¹¹ to R¹¹⁴ is the substituent RA or the group represented by —O—RA; M1 is a tetravalent atom;
   in the formula (12), R¹²¹ to R¹²³ are independently a hydrogen atom, a substituent RA, or a group represented by —O—RA, and at least one of R¹²¹ to R¹²³ is the substituent RA or the group represented by —O—RA; M2 is a trivalent atom;
   in the formula (13), R¹³¹ to R¹³³ are independently a hydrogen atom, a substituent RA, or a group represented by —O—RA, and at least one of R¹³¹ to R¹³³ is the substituent RA or the group represented by —O—RA; M3 is a trivalent organic group including a triazine skeleton; in the formula (14), R¹⁴¹ and R¹⁴² are independently a hydrogen atom, a substituent RA, or a group represented by —O—RA, and at least one of R¹⁴¹ and R¹⁴² is the substituent RA or the group represented by —O—RA;
   in the formula (15), R¹⁵¹ to R¹⁵³ are independently a hydrogen atom, a substituent RA, or a group represented by —O—RA, and at least one of R¹⁵¹ to R¹⁵³ is the substituent RA or the group represented by —O—RA;
   in the formula (16), R¹⁶¹ and R¹⁶² are independently a substituent RA;
   in the formula (17), R¹⁷¹ to R¹⁷³ are independently a hydrogen atom or a substituent RA, and at least one of R¹⁷¹ to R¹⁷³ is the substituent RA; and
   the substituent RA is a substituted or unsubstituted alkyl group having 1 to 50 carbon atoms, a substituted or unsubstituted alkenyl group having 2 to 50 carbon atoms, a substituted or unsubstituted alkynyl group having 2 to 50 carbon atoms, a substituted or unsubstituted cycloalkyl group having 3 to 50 ring carbon atoms, a substituted or unsubstituted aryl group having 6 to 50 ring carbon atoms, or a substituted or unsubstituted monovalent heterocyclic group having 5 to 50 ring atoms.
2. The solid electrolyte composition according to 1, wherein R¹¹ to R¹³ in the formula (1) of the component (B) are independently a substituted or unsubstituted alkyl group having 1 to 50 carbon atoms, or a substituted or unsubstituted aryl group having 6 to 50 ring carbon atoms.
3. The solid electrolyte composition according to 1 or 2, wherein R¹¹ to R¹³ in the formula (1) of the component (B) are independently a substituted or unsubstituted alkyl group having 1 to 50 carbon atoms.
4. The solid electrolyte composition according to any one of 1 to 3, wherein R²¹ to R²⁶ in the formula (2) of the component (B) are independently a substituted or unsubstituted alkyl group having 1 to 50 carbon atoms.
5. The solid electrolyte composition according to any one of 1 to 4, wherein R³¹ to R³³ in the formula (3) of the component (B) are independently a substituted or unsubstituted alkyl group having 1 to 50 carbon atoms.
6. The solid electrolyte composition according to any one of 1 to 5, wherein R⁵¹ in the formula (5) of the component (B) is a substituted or unsubstituted alkyl group having 1 to 50 carbon atoms.
7. The solid electrolyte composition according to any one of 1 to 6, wherein R⁶¹ in the formula (6) of the component (B) is a substituted or unsubstituted alkenyl group having 2 to 50 carbon atoms.
8. The solid electrolyte composition according to any one of 1 to 7, wherein R⁷¹ in the formula (7) of the component (B) is a substituted or unsubstituted alkenyl group having 2 to 50 carbon atoms.
9. The solid electrolyte composition according to any one of 1 to 8, wherein R⁸¹ to R⁸³ in the formula (8) of the component (B) are independently a substituted or unsubstituted alkyl group having 1 to 50 carbon atoms.
10. The solid electrolyte composition according to any one of 1 to 9, wherein R⁹¹ in the formula (9) of the component (B) is a substituted or unsubstituted alkyl group having 1 to 50 carbon atoms.
11. The solid electrolyte composition according to any one of 1 to 10, wherein R¹⁰¹ to R¹⁰³ in the formula (10) of the component (B) are independently a substituted or unsubstituted alkyl group having 1 to 50 carbon atoms.
12. The solid electrolyte composition according to any one of 1 to 11, wherein M1 in the formula (11) of the component (B) is silicon (Si) atom, titanium (Ti) atom, germanium (Ge) atom, zirconium (Zr) atom, tin (Sn) atom, hafnium (Hf) atom, or lead (Pb) atom.
13. The solid electrolyte composition according to any one of 1 to 12, wherein R¹¹¹ to R¹¹⁴ in the formula (11) of the component (B) are independently a group represented by —O—RA.
14. The solid electrolyte composition according to any one of 1 to 12, wherein R¹¹¹ to R¹¹⁴ in the formula (11) of the component (B) are independently a group represented by —O—RA, and RA is a substituted or unsubstituted alkyl group having 1 to 50 carbon atoms.
15. The solid electrolyte composition according to any one of 1 to 12, wherein in the formula (11) of the component (B), some of R¹¹¹ to R¹¹⁴ are independently a group represented by —O—RA, and the other R¹¹¹ to R¹¹⁴ are independently a substituent RA.
16. The solid electrolyte composition according to any one of 1 to 12, wherein in the formula (11) of the component (B), some of R¹¹¹ to R¹¹⁴ are independently a group represented by —O—RA, the other R¹¹¹ to R¹¹⁴ are independently a substituent RA, and RA is a substituted or unsubstituted alkyl group having 1 to 50 carbon atoms.
17. The solid electrolyte composition according to any one of 1 to 16, wherein M2 in the formula (12) of the component (B) is boron (B) atom, aluminum (Al) atom, scandium (Sc) atom, gallium (Ga) atom, yttrium (Y) atom, indium (In) atom, or gadolinium (Gd) atom.
18. The solid electrolyte composition according to any one of 1 to 17, wherein R¹²¹ to R¹²³ in the formula (12) of the component (B) are independently a group represented by —O—RA.
19. The solid electrolyte composition according to any one of 1 to 17, wherein R¹²¹ to R¹²³ in the formula (12) of the component (B) are independently a group represented by —O—RA, and RA is a substituted or unsubstituted alkyl group having 1 to 50 carbon atoms.
20. The solid electrolyte composition according to any one of 1 to 19, wherein the component (B) is one or more compounds selected from the compounds represented by the formulas (1), (3), (5), (8), (10), (11), (12) and (14) to (16).
21. The solid electrolyte composition according to any one of 1 to 20, wherein the amount of the component (B) is 0.1 to 20% by mass based on the total amount of the component (A) and the component (B).
22. The solid electrolyte composition according to any one of 1 to 21, wherein the component (B) is a compound comprising a group having a chain length of 4 or more carbon atoms.
23. The solid electrolyte composition according to any one of 1 to 22, wherein the component (A) further comprises a halogen atom.
24. The solid electrolyte composition according to any one of 1 to 23, wherein the component (A) comprises one or more elements selected from the group consisting of chlorine (Cl), bromine (Br) and iodine (1).
25. The solid electrolyte composition according to any one of 1 to 24, wherein the component (A) comprises chlorine (Cl).
26. The solid electrolyte composition according to any one of 1 to 25, wherein the component (A) comprises chlorine (Cl) and bromine (Br).
27. The solid electrolyte composition according to any one of 1 to 26, wherein the component (A) has a crystalline structure.
28. The solid electrolyte composition according to any one of 1 to 27, wherein the component (A) has argyrodite type crystalline structure.
29. The solid electrolyte composition according to any one of 1 to 27, wherein the component (A) has a thio-LISICON Region II type crystalline structure.
30. The solid electrolyte composition according to any one of 1 to 29, which comprises (C) a solvent.
31. The solid electrolyte composition according to any one of 1 to 29, which does not substantially include (C) a solvent.
32. The solid electrolyte composition according to any one of 1 to 31, which comprises (D) an electrode active material.
33. A solid electrolyte layer or an electrode mixture obtained from the solid electrolyte composition according to any one of 1 to 32.
34. A lithium-ion battery comprising the solid electrolyte layer or the electrode mixture according to 33.
35. A lithium-ion battery comprising an electrode and a solid electrolyte layer, wherein at least one of the electrode and the solid electrolyte layer comprises (A) a sulfide solid electrolyte comprising lithium, phosphorus and sulfur, and (B) one or more compounds selected from compounds represented by the following formulas (1) to (17):

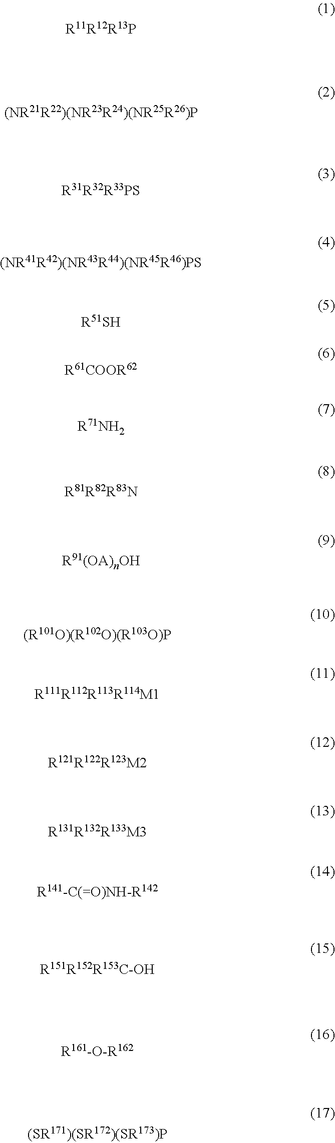

wherein in the formula (1), R¹¹ to R¹³ are independently a hydrogen atom or a substituent RA, and at least one of R¹¹ to R¹³ is the substituent RA;
   in the formula (2), R²¹ to R²⁶ are independently a hydrogen atom or a substituent RA, and at least one of R²¹ to R²⁶ is the substituent RA;
   in the formula (3), R³¹ to R³³ are independently a hydrogen atom or a substituent RA, and at least one of R³¹ to R³³ is the substituent RA;
   in the formula (4), R⁴¹ to R⁴⁶ are independently a hydrogen atom or a substituent RA, and at least one of R⁴¹ to R⁴⁶ is the substituent RA;
   in the formula (5), R⁵¹ is a substituent RA;
   in the formula (6), R⁶¹ is a substituent RA, and R⁶² is a hydrogen atom or a substituent RA; in the formula (7), R⁷¹ is a substituent RA;
   in the formula (8), R⁸¹ to R⁸³ are independently a hydrogen atom or a substituent RA, and at least one of R⁸¹ to R⁸³ is the substituent RA;
   in the formula (9), R⁹¹ is a substituent RA, and A is an alkylene group having 2 to 4 carbon atoms; n is 1 to 20;
   in the formula (10), R¹⁰¹ to R¹⁰³ are independently a hydrogen atom or a substituent RA, and at least one of R¹⁰¹ to R¹⁰³ is the substituent RA;
   in the formula (11), R¹¹¹ to R¹¹⁴ are independently a hydrogen atom, a substituent RA, or a group represented by —O—RA, and at least one of R¹¹¹ to R¹¹⁴ is the substituent RA or the group represented by —O—RA; M1 is a tetravalent atom;
   in the formula (12), R¹²¹ to R¹²³ are independently a hydrogen atom, a substituent RA, or a group represented by —O—RA, and at least one of R¹²¹ to R¹²³ is the substituent RA or the group represented by —O—RA; M2 is a trivalent atom;
   in the formula (13), R¹³¹ to R¹³³ are independently a hydrogen atom, a substituent RA, or a group represented by —O—RA, and at least one of R¹³¹ to R¹³³ is the substituent RA or the group represented by —O—RA; M3 is a trivalent organic group including a triazine skeleton; in the formula (14), R¹⁴¹ and R¹⁴² are independently a hydrogen atom, a substituent RA, or a group represented by —O—RA, and at least one of R¹⁴¹ and R¹⁴² is the substituent RA or the group represented by —O—RA;
   in the formula (15), R¹⁵¹ to R¹⁵³ are independently a hydrogen atom, a substituent RA, or a group represented by —O—RA, and at least one of R¹⁵¹ to R¹⁵³ is the substituent RA or the group represented by —O—RA;
   in the formula (16), R¹⁶¹ and R¹⁶² are independently a substituent RA;
   in the formula (17), R¹⁷¹ to R¹⁷³ are independently a hydrogen atom or a substituent RA, and at least one of R¹⁷¹ to R¹⁷³ is the substituent RA; and
   the substituent RA is a substituted or unsubstituted alkyl group having 1 to 50 carbon atoms, a substituted or unsubstituted alkenyl group having 2 to 50 carbon atoms, a substituted or unsubstituted alkynyl group having 2 to 50 carbon atoms, a substituted or unsubstituted cycloalkyl group having 3 to 50 ring carbon atoms, a substituted or unsubstituted aryl group having 6 to 50 ring carbon atoms, or a substituted or unsubstituted monovalent heterocyclic group having 5 to 50 ring atoms.

According to the present invention, a solid electrolyte composition having high dense when it is compressed, and capable of achieving high ionic conductivity can be provided.

### BRIEF DESCRIPTION OF THE DRAWINGS

FIG. 1 is a diagram illustrating ¹H-NMR spectrum measured by a solid electrolyte composition of Example 1 and ¹H-NMR spectrum measured by a component B1 (TOP) arranged vertically.

### MODE FOR CARRYING OUT THE INVENTION

Hereinafter, a solid electrolyte composition, a solid electrolyte layer or an electrode mixture, and a lithium-ion battery according to the present invention will be described. As used herein, the term “x to y” refers to a numerical range of “x or more and y or less”. With regard to one technical matter, when a plurality of lower limit values such as “x or more” are present, or when a plurality of upper limit values such as “y or less” are present, the upper limit value and the lower limit value can be arbitrarily selected and combined.

1. Solid electrolyte composition

A solid electrolyte composition according to an aspect of the present invention includes the following component (A) and component (B):
(A) a sulfide solid electrolyte including lithium, phosphorus and sulfur, and
(B) one or more compounds selected from compounds represented by the following formulas (1) to (17):

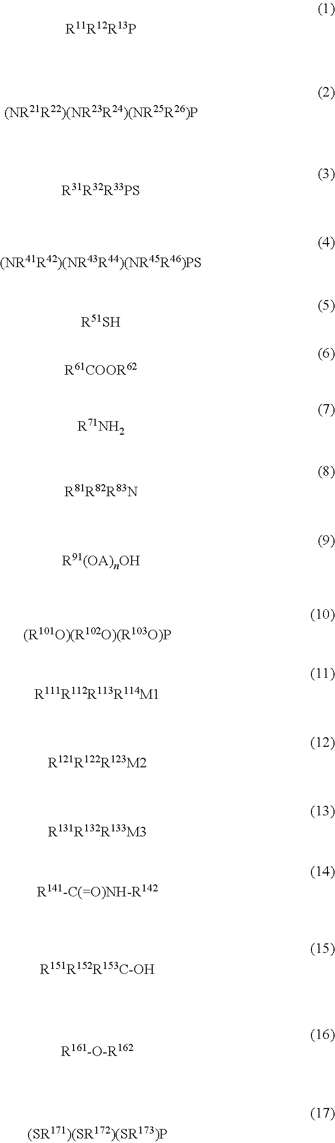

wherein in the formula (1), R¹¹ to R¹³ are independently a hydrogen atom or a substituent RA, and at least one of R¹¹ to R¹³ is the substituent RA;
in the formula (2), R²¹ to R²⁶ are independently a hydrogen atom or a substituent RA, and at least one of R²¹ to R²⁶ is the substituent RA;
in the formula (3), R³¹ to R³³ are independently a hydrogen atom or a substituent RA, and at least one of R³¹ to R³³ is the substituent RA;
in the formula (4), R⁴¹ to R⁴⁶ are independently a hydrogen atom or a substituent RA, and at least one of R⁴¹ to R⁴⁶ is the substituent RA;
in the formula (5), R⁵¹ is a substituent RA;
in the formula (6), R⁶¹ is a substituent RA, and R⁶² is a hydrogen atom or a substituent RA; in the formula (7), R⁷¹ is a substituent RA;
in the formula (8), R⁸¹ to R⁸³ are independently a hydrogen atom or a substituent RA, and at least one of R⁸¹ to R⁸³ is the substituent RA;
in the formula (9), R⁹¹ is a substituent RA, and A is an alkylene group having 2 to 4 carbon atoms; n is 1 to 20;
in the formula (10), R¹⁰¹ to R¹⁰³ are independently a hydrogen atom or a substituent RA, and at least one of R¹⁰¹ to R¹⁰³ is the substituent RA;
in the formula (11), R¹¹¹ to R¹¹⁴ are independently a hydrogen atom, a substituent RA, or a group represented by —O—RA, and at least one of R¹¹¹ to R¹¹⁴ is the substituent RA or the group represented by —O—RA; M1 is a tetravalent atom;
in the formula (12), R¹²¹ to R¹²³ are independently a hydrogen atom, a substituent RA, or a group represented by —O—RA, and at least one of R¹²¹ to R¹²³ is the substituent RA or the group represented by —O—RA; M2 is a trivalent atom;
in the formula (13), R¹³¹ to R¹³³ are independently a hydrogen atom, a substituent RA, or a group represented by —O—RA, and at least one of R¹³¹ to R¹³³ is the substituent RA or the group represented by —O—RA; M3 is a trivalent organic group including a triazine skeleton;
in the formula (14), R¹⁴¹ and R¹⁴² are independently a hydrogen atom, a substituent RA, or a group represented by —O—RA, and at least one of R¹⁴¹ and R¹⁴² is the substituent RA or the group represented by —O—RA;
in the formula (15), R¹⁵¹ to R¹⁵³ are independently a hydrogen atom, a substituent RA, or a group represented by —O—RA, and at least one of R¹⁵¹ to R¹⁵³ is the substituent RA or the group represented by —O—RA;
in the formula (16), R¹⁶¹ and R¹⁶² are independently a substituent RA;
in the formula (17), R¹⁷¹ to R¹⁷³ are independently a hydrogen atom or a substituent RA, and at least one of R¹⁷¹ to R¹⁷³ is the substituent RA; and
the substituent RA is a substituted or unsubstituted alkyl group having 1 to 50 carbon atoms, a substituted or unsubstituted alkenyl group having 2 to 50 carbon atoms, a substituted or unsubstituted alkynyl group having 2 to 50 carbon atoms, a substituted or unsubstituted cycloalkyl group having 3 to 50 ring carbon atoms, a substituted or unsubstituted aryl group having 6 to 50 ring carbon atoms, or a substituted or unsubstituted monovalent heterocyclic group having 5 to 50 ring atoms.

When the solid electrolyte composition described above includes the component (B) in addition to a solid electrolyte, it can exhibit highly dense in the case where it is compressed. Specifically, the amount of the solid electrolyte compound per unit volume can be increased, and thus, a dense structure with less voids can be obtained. As a result, the contact between the solid electrolytes and the contact between the active material and the solid electrolyte can be increased, and thus, the battery performance can be further increased.

Although the mechanism of the above effects is not always clear, it is considered that the mechanism is caused by the friction reducing action of the component (B) having a specific structure. That is, it is considered that the component (B) is adsorbed (physisorbed or chemisorbed) on the surface of the solid electrolyte particles and enters between the solid electrolyte particles, so to speak, functions as a sliding layer to reduce the frictional force between the particles, thereby enhancing the rearrangeability at the time of compression and enabling a dense structure with less voids.

When the solid electrolyte is added to organic material, the ionic conductivity is inevitably lowered as compared with when the solid electrolyte is used alone, but by using the component (B), the decrease in the ionic conductivity can be minimized, and the highly ionic conductivity can be maintained. Such an effect is also considered to be caused by the action of the component (B) having a specific structure.

Hereinafter, the component of the solid electrolyte composition according to an aspect of the present invention will be described.

### (Component (A): Solid Electrolyte)

A component (A) is not particularly limited as long as it is a sulfide solid electrolyte containing a particular element, and any solid electrolyte may be used.

The sulfide solid electrolyte is a solid electrolyte containing at least sulfur atom and exhibiting the ionic conductivity due to the contained metallic atom, and it is preferably a solid electrolyte including lithium atom and phosphorus atom in addition to sulfur atom, and more preferably lithium atom, phosphorus atom and a halogen atom, and having the ionic conductivity due to lithium atom.

The sulfide solid electrolyte may be an amorphous sulfide solid electrolyte, or it may be a crystalline sulfide solid electrolyte.

### (Amorphous Sulfide Solid Electrolyte)

An amorphous sulfide solid electrolyte is a solid electrolyte which exhibits a halo pattern in which a peak other than a peak derived from material is not substantially observed in an X-ray diffractometry, and which may or may not have a peak derived from a solid raw material. The amorphous sulfide solid electrolyte includes at least sulfur atom and can be employed without any particular limitation as long as it exhibits ionic conductivity caused by the contained metal atom, and typical examples thereof preferably include a solid electrolyte such as Li₂S—P₂S₅(Li₃PS₄) composed of lithium sulfide and phosphorus sulfide and including sulfur atom, lithium atom and phosphorus atom; a solid electrolyte such as Li₂S—P₂S₅—LiI, Li₂S—P₂S₅—LiCl, Li₂S—P₂S₅—LiBr and Li₂S—P₂S₅—LiI—LiBr composed of lithium sulfide, phosphorus sulfide, and lithium halide; and a solid electrolyte including other elements such as oxygen element and silicon element, for example, such as Li₂S—P₂S₅—Li₂O—LiI and Li₂S—SiS₂—P₂S₅—LiI. From the viewpoint of obtaining higher ionic conductivity, the solid electrolyte such as Li₂S—P₂S₅—LiI, Li₂S—P₂S₅—LiCl, Li₂S—P₂S₅—LiBr, Li₂S—P₂S₅—LiI—LiBr composed of lithium sulfide, phosphorus sulfide, and lithium halide, is preferable.

The kind of the element constituting the amorphous sulfide solid electrolyte can be identified by, for example, an ICP emission spectrometer.

When the amorphous sulfide solid electrolyte has at least a Li₂S—P₂S₅, the molar ratio of Li₂S to P₂S₅ is preferably 65 to 85:15 to 35, more preferably 70 to 80:20 to 30, and still more preferably 72 to 78:22 to 28, from the viewpoint of obtaining higher ionic conductivity.

When the amorphous sulfide solid electrolyte is, for example, Li₂S—P₂S₅—LiI—LiBr, the total amount of lithium sulfide and phosphorus pentasulfide is preferably 60 to 95 mol %, more preferably 65 to 90 mol %, and still more preferably 70 to 85 mol %. The amount of lithium bromide is preferably 1 to 99 mol %, more preferably 20 to 90 mol %, still more preferably 40 to 80 mol %, and particularly preferably 50 to 70 mol %, based on the total amount of lithium bromide and lithium iodide.

In the amorphous sulfide solid electrolyte, when lithium atom, sulfur atom, phosphorus atom, and the halogen atom are included, the blending proportion (molar proportion) of these atoms is preferably 1.0 to 1.8:1.0 to 2.0:0.1 to 0.8:0.01 to 0.6, more preferably 1.1 to 1.7:1.2 to 1.8:0.2 to 0.6:0.05 to 0.5, and still more preferably 1.2 to 1.6:1.3 to 1.7:0.25 to 0.5:0.08 to 0.4.

Also, when bromine and iodine are used in combination as the halogen atom, the blending proportion (molar proportion) of lithium atom, sulfur atom, phosphorus atom, bromine atom, and iodine atom is preferably 1.0 to 1.8:1.0 to 2.0:0.1 to 0.8:0.01 to 0.3:0.01 to 0.3, more preferably 1.1 to 1.7:1.2 to 1.8:0.2 to 0.6:0.02 to 0.25:0.02 to 0.25, and more preferably 1.2 to 1.6:1.3 to 1.7:0.25 to 0.5:0.03 to 0.2:0.03 to 0.2, and still more preferably is 1.35 to 1.45:1.4 to 1.7:0.3 to 0.45:0.04 to 0.18:0.04 to 0.18. When the blending proportion (molar proportion) of lithium atom, sulfur atom, phosphorus atom and the halogen atom is within the above range, it is easy to obtain a solid electrolyte having a higher ionic conductivity having a thio-LISICON Region II type crystalline structure, which will be described later.

The form of the amorphous sulfide solid electrolyte is not particularly limited, and examples thereof include particulate forms. The average particle size (D₅₀) of the particulate amorphous sulfide solid electrolyte may be, for example, in the range of 0.01 μm to 500 μm and 0.1 to 200 μm.

In the present specification, the average particle diameter (D₅₀) is a particle diameter that reaches 50% of the total by sequential integration of the particles having the smallest particle diameter when the particle diameter distribution integration curve is drawn, and the volume distribution is an average particle diameter that can be measured using, for example, a laser diffraction/scattering particle diameter distribution measuring device.

### (Crystalline Sulfide Solid Electrolyte)

The crystalline sulfide solid electrolyte is the solid electrolyte in which a peak derived from solid electrolyte is observed in an X-ray diffraction pattern in an X-ray diffractometry, and it is a material with or without a peak derived from a solid raw material. That is, the crystalline sulfide solid electrolyte includes a crystal structure derived from solid electrolyte, and a part thereof may be a crystal structure derived from solid electrolyte, or the entire crystalline sulfide solid electrolyte may be a crystal structure derived from solid electrolyte. As long as the crystalline sulfide solid electrolyte has the above-described X-ray diffractogram, a part thereof may contain an amorphous solid electrolyte.

The crystalline sulfide solid electrolyte may be, for example, a so-called glass ceramic obtained by heating the amorphous sulfide solid electrolyte above to a crystallization temperature or higher, and a sulfide solid electrolyte having the following crystal structure may be used.

Examples of the crystalline structure that can be possessed by the crystalline sulfide solid electrolyte including lithium atom, sulfur atom, and phosphorus atom include a Li₃PS₄ crystalline structure, a Li₄P2S₆ crystalline structure, a Li₇PS₆ crystalline structure, a Li₇P₃S₁₁ crystalline structure, and a crystalline structure having peaks in the vicinity of 2θ=20.2° and in the vicinity of 23.6° (for example, JP 2013-16423 A).

Examples of the crystalline structure that can be possessed by the crystalline sulfide solid electrolyte including lithium atom, sulfur atom, phosphorus atom and the halogen atom include a Li₄₋ₓGe₁₋ₓPₓS₄ thio-LISICON Region II type crystalline structure (see Kanno et al., Journal of The Electrochemical Society, 148 (7) A742-746 (2001)), a crystalline structure similar to that of Li₄₋ₓGe₁₋ₓPₓS₄ thio-LISICON Region II type (see Solid State Ionics, 177 (2006), 2721-2725), and the like. Here, it is indicated that the “thio-LISICON Region II type crystalline structure” is any of Li₄₋ₓGe₁₋ₓPₓS₄ system thio-LISICON Region II type crystalline structure or a crystalline structure similar to Li₄₋ₓGe₁₋ₓPₓS₄ system thio-LISICON Region II type.

In X-ray diffraction measurement using CuKα rays, diffraction peaks of Li₃PS₄ crystalline structure appear, for example, around 2θ=17.5°, 18.3°, 26.1°, 27.3°, and 30.0°, diffraction peaks of Li₄P₂S₆ crystalline structure appear, for example, around 2θ=16.9°, 27.1°, and 32.5°, diffraction peaks of Li₇PS₆ crystalline structure appear, for example, around 2θ=15.3°, 25.2°, 29.6°, and 31.0°, diffraction peaks of Li₇P₃S₁₁ crystalline structure appear, for example, around 2θ=17.8°, 18.5°, 19.7°, 21.8°, 23.7°, 25.9°, 29.6°, and 30.0°, diffraction peaks of Li₄₋ₓGe₁₋ₓPₓS₄ system thio-LISICON Region II type crystalline structure appear, for example, around 2θ=20.1°, 23.9°, and 29.5°, and diffraction peaks of the crystalline structure similar to Li₄₋ₓGe₁₋ₓPₓS₄ system thio-LISICON Region II type crystalline structure appear, for example, around 2θ=20.2° and 23.6°. The peak position may be about ±0.5°.

In addition, examples of the crystalline structure of the crystalline sulfide solid electrolyte also include argyrodite type crystalline structure. Examples of argyrodite type crystalline structure include a Li₇PS₆ crystalline structure; crystalline structures represented by compositional formulas represented by Li₇₋ₓP_{1-y}Si_{y}S₆ and Li₇₊ₓP_{1-y}Si_{y}S₆ (x is −0.6 to 0.6, y is 0.1 to 0.6) having a Li₇PS₆ structural skeleton and consisting of a portion of P substituted with Si; a crystalline structure represented by Li_{7-x-2y}PS_{6-x-y}Clₓ (0.8≤x≤1.7, 0≤y≤−0.25x+0.5); and a crystalline structure represented by Li₇₋ₓPS₆₋ₓHaₓ (Ha is Cl or Br, and x is preferably 0.2 to 1.8).

Among the above crystalline structures, the crystalline structure of the crystalline sulfide solid electrolyte is preferably a Li₃PS₄ crystalline structure, a thio-LISICON Region II crystalline structure, or an argyrodite type crystalline structure.

The form of the crystalline sulfide solid electrolyte is not particularly limited, and examples thereof include particulate forms. The average particle size (D₅₀) of the particulate crystalline sulfide solid electrolyte may be, for example, in the range of 0.01 μm to 500 μm and 0.1 to 200 μm, similar to the average particle size (D₅₀) of the amorphous sulfide solid electrolyte described above.

### (Component (B): Compounds Represented by Formulas (1) to (17))

As the component (B), any one of compounds represented by the formulas (1) to (17) is used. One of these may be used alone, or two or more of them may be used in combination. Impurities which are not substantially removed or refinable generated in the producing process of the component (B) may be included.

In one embodiment, the component (B) is a compound including a group having 4 or more carbon atoms. Examples of the group having 4 or more carbon atoms include an amino group having 4 or more total carbon atoms, and a group derived from a chain hydrocarbon compound having 4 or more carbon atoms. Examples of the amino group having 4 or more total carbon atoms include a dialkylamino group, and the number of carbon atoms of each alkyl moiety is, for example, 2 to 10.

The upper limit of the number of carbon atoms of the group having 4 or more carbon atoms is not particularly limited, but is, for example, 30 or less, 25 or less, or 20 or less.

The component (B) may be a compound including 2 or 3 or more groups having 4 or more carbon atoms. In this case, each of the groups may be the same as or different from each other.

In one embodiment, when it includes 2 or 3 or more groups having 4 or more carbon atoms, the total number of carbon atoms thereof is 10 or more, 12 or more, or 15 or more. The upper limit of the number of carbon atoms thereof in this case is not particularly limited, but it is, for example, 60 or less, 50 or less, or 40 or less.

In one embodiment, the component (B) is a compound including a group having a chain length of 4 or more carbon atoms. The chain length refers to the longest number of carbon atoms in the straight chain moiety among the chain structure of the group. Examples of the group having a chain length of 4 or more carbon atoms include a group derived from a chain hydrocarbon compound having 4 or more carbon atoms, and examples thereof include an alkyl group having 4 or more carbon atoms.

The upper limit of the number of carbon atoms of the group having a chain length of 4 or more carbon atoms is not particularly limited, but it is, for example, 30 or less, 25 or less, or 20 or less.

The component (B) may be a compound including 2 or 3 or more groups having a chain length of 4 or more carbon atoms. In this case, each of the groups may be the same as or different from each other.

In one embodiment, when it includes 2 or 3 or more groups having a chain length of 4 or more carbon atoms, the total number of carbon atoms thereof is 10 or more, 12 or more, or 15 or more. The upper limit of the number of carbon atoms thereof in this case is not particularly limited, but it is, for example, 60 or less, 50 or less, or 40 or less.

In one embodiment, the molecular weight of the component (B) is 1 to 10,000, 1 to 5,000, 1 to 3,000, or 1 to 1,000.

Hereinafter, each of the components (B) will be described.

The substituent RA in the formulas (1) to (17) is a substituted or unsubstituted alkyl group having 1 to 50 carbon atoms, a substituted or unsubstituted alkenyl group having 2 to 50 carbon atoms, a substituted or unsubstituted alkynyl group having 2 to 50 carbon atoms, a substituted or unsubstituted cycloalkyl group having 3 to 50 ring carbon atoms, a substituted or unsubstituted aryl group having 6 to 50 ring carbon atoms, or a substituted or unsubstituted monovalent heterocyclic group having 5 to 50 ring atoms, and when a plurality of RA's is present in one compound, the plurality of RA's may be the same as or different from each other.

As a substituent in the case of “substituted or unsubstituted”, examples thereof include an alkyl group having 1 to 50 of carbon atoms, an alkoxy group having 1 to 50 carbon atoms, an alkenyl group having 2 to 50 carbon atoms, an alkynyl group having 2 to 50 carbon atoms, an cycloalkyl group having 3 to 50 ring carbon atoms, an aryl group having 6 to 50 ring carbon atoms, a monovalent heterocyclic group having 5 to 50 ring atoms, a group represented by —N(R^{S1})(R^{S2}) (R^{S1} and R^{S2} are independently a hydrogen atom, an alkyl group having 1 to 50 carbon atoms, an alkenyl group having 2 to 50 carbon atoms, an alkynyl group having 2 to 50 carbon atoms, a cycloalkyl group having 3 to 50 ring carbon atoms, an aryl group having 6 to 50 ring carbon atoms, or a monovalent heterocyclic group having 5 to 50 ring atoms), a group represented by —Si(R^{S3})(R^{S4})(R^{S5}) (R^{S3} to R^{S5} are independently a hydrogen atom, an alkyl group having 1 to 50 carbon atoms, an alkoxy group having 1 to 50 carbon atoms, an alkenyl group having 2 to 50 carbon atoms, an alkynyl group having 2 to 50 carbon atoms, a cycloalkyl group having 3 to 50 ring carbon atoms, an aryl group having 6 to 50 ring carbon atoms, or a monovalent heterocyclic group having 5 to 50 ring atoms), an acryloyl group, a methacryloyl group, and the like.

In one embodiment, the substituent RA is an unsubstituted group.

### (Compound Represented by Formula (1))

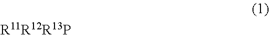

In the formula (1), R¹¹ to R¹³ are independently a hydrogen atom or a substituent RA, and at least one of R¹¹ to R¹³ is the substituent RA.

In one embodiment, R¹¹ to R¹³ are independently a substituted or unsubstituted alkyl group having 1 to 50 carbon atoms. The number of carbon atoms may be, for example, 1 to 30, 1 to 20 or 1 to 15.

In one embodiment, R¹¹ to R¹³ are independently a substituted or unsubstituted alkyl group having 4 to 20 carbon atoms. The total number of carbon atoms of R¹¹ to R¹³ may be 12 to 60, 12 to 50, or 12 to 40.

In one embodiment, R¹¹ to R¹³ are independently a substituted or unsubstituted aryl group having 6 to 50 ring carbon atoms. The number of carbon atoms may be, for example, 6 to 20, 6 to 10 or 6 to 10.

### (Compound Represented by Formula (2))

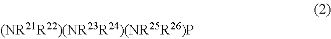

In the formula (2), R²¹ to R²⁶ are independently a hydrogen atom or a substituent RA, and at least one of R²¹ to R²⁶ is the substituent RA.

In one embodiment, R²¹ to R²⁶ are independently a substituted or unsubstituted alkyl group having 1 to 50 carbon atoms. The number of carbon atoms may be, for example, 1 to 30, 1 to 20 or 1 to 15.

### (Compound Represented by Formula (3))

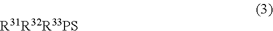

In the formula (3), R³¹ to R³³ is independently a hydrogen atom or a substituent RA, and at least one of R³¹ to R³³ is the substituent RA.

In one embodiment, R³¹ to R³³ are independently a substituted or unsubstituted alkyl group having 1 to 50 carbon atoms. The number of carbon atoms may be, for example, 1 to 30, 1 to 20 or 1 to 15.

In one embodiment, R³¹ to R³³ are independently a substituted or unsubstituted alkyl group having 4 to 20 carbon atoms. The total number of carbon atoms of R³¹ to R³³ may be 12 to 60, 12 to 50, or 12 to 40.

### (Compound Represented by Formula (4))

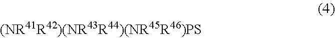

In the formula (4), R⁴¹ to R⁴⁶ is independently a hydrogen atom or a substituent RA, and at least one of R⁴¹ to R⁴⁶ is the substituent RA.

### (Compound Represented by Formula (5))

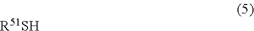

In the formula (5), R⁵¹ is a substituent RA.

In one embodiment, R⁵¹ is a substituted or unsubstituted alkyl group having 1 to 50 carbon atoms. The number of carbon atoms may be, for example, 1 to 30, 1 to 20, or 1 to 15.

In one embodiment, R⁵¹ is a substituted or unsubstituted alkyl group having 4 to 20 carbon atoms. In this case, the number of carbon atoms may be, for example, 5 to 20, or 10 to 20.

### (Compound Represented by Formula (6))

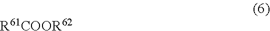

In the formula (6), R⁶¹ is a substituent RA, and R⁶² is a hydrogen atom or a substituent RA.

In one embodiment, R⁶¹ is a substituted or unsubstituted alkenyl group having 2 to 50 carbon atoms. The number of carbon atoms may be, for example, 2 to 40, or 2 to 30. When R⁶¹ is a substituted or unsubstituted alkenyl group having 2 to 50 carbon atoms, R⁶² is, for example, a hydrogen atom.

In one embodiment, R⁶¹ is a substituted or unsubstituted alkenyl group having 4 to 20 carbon atoms. In this case, the number of carbon atoms may be, for example, 5 to 20, or 10 to 20. When R⁶¹ is a substituted or unsubstituted alkenyl group having 4 to 20 carbon atoms, R⁶² is, for example, a hydrogen atom.

In one embodiment, R⁶¹ is a substituted or unsubstituted alkyl group having 1 to 50 carbon atoms. The number of carbon atoms thereof may be, for example, 1 to 30, 1 to 20, 1 to 15, or 5 to 20. When R⁶¹ is a substituted or unsubstituted alkyl group having 1 to 50 carbon atoms, R⁶² is, for example, a substituted or unsubstituted alkenyl group having 2 to 50 carbon atoms. The number of carbon atoms thereof may be, for example, 2 to 40, or 2 to 30.

### (Compound Represented by Formula (7))

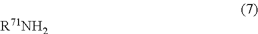

In the formula (7), R⁷¹ is a substituent RA.

In one embodiment, R⁷¹ is a substituted or unsubstituted alkenyl group having 2 to 50 carbon atoms. The number of carbon atoms may be, for example, 2 to 40, or 2 to 30.

In one embodiment, R⁷¹ is a substituted or unsubstituted alkenyl group having 4 to 20 carbon atoms. In this case, the number of carbon atoms may be, for example, 5 to 20, or 10 to 20.

### (Compound Represented by Formula (8))

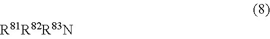

In the formula (8), R⁸¹ to R⁸³ are independently a hydrogen atom or a substituent RA, and at least one of R⁸¹ to R⁸³ is the substituent RA.

In one embodiment, R⁸¹ to R⁸³ are independently a substituted or unsubstituted alkyl group having 1 to 50 carbon atoms. The number of carbon atoms may be, for example, 1 to 30, 1 to 20 or 1 to 15.

In one embodiment, R⁸¹ to R⁸³ are independently a substituted or unsubstituted alkyl group having 4 to 20 carbon atoms. The total number of carbon atoms of R⁸¹ to R⁸³ may be 12 to 60, 12 to 50, or 12 to 40.

### (Compound Represented by Formula (9))

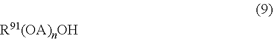

In the formula (9), R⁹¹ is a substituent RA, and A is an alkylene group having 2 to 4 carbon atoms (for example, ethylene oxide group). n is 1 to 20.

In one embodiment, R⁹¹ is a substituted or unsubstituted alkyl group having 1 to 50 carbon atoms. The number of carbon atoms may be, for example, 1 to 30, 1 to 20 or 1 to 15.

In one embodiment, R⁹¹ is a substituted or unsubstituted alkyl group having 4 to 20 carbon atoms. In this case, the number of carbon atoms may be, for example, 5 to 20, or 10 to 20.

### (Compound Represented by Formula (10))

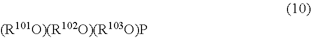

In the formula (10), R¹⁰¹ to R¹⁰³ are independently a hydrogen atom or a substituent RA, and at least one of R¹⁰¹ to R¹⁰³ is the substituent RA.

In one embodiment, R¹⁰¹ to R¹⁰³ are independently a substituted or unsubstituted alkyl group having 1 to 50 carbon atoms. The number of carbon atoms may be, for example, 1 to 30, 1 to 20 or 1 to 15.

In one embodiment, R¹⁰¹ to R¹⁰³ are independently a substituted or unsubstituted alkyl group having 4 to 20 carbon atoms. The total number of carbon atoms of R¹⁰¹ to R¹⁰³ may be 12 to 60, 12 to 50, or 12 to 40.

### (Compound Represented by Formula (11))

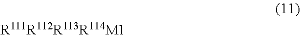

In the formula (11), R¹¹¹ to R¹¹⁴ are independently a hydrogen atom, a substituent RA, or a group represented by —O—RA, and at least one of R¹¹¹ to R¹¹⁴ is the substituent RA or the group represented by —O—RA. M1 is a tetravalent atom.

In one embodiment, M1 is silicon (Si) atom, titanium (Ti) atom, germanium (Ge) atom, zirconium (Zr) atom, tin (Sn) atom, hafnium (Hf) atom, or lead (Pb) atom, and it is, for example, silicon (Si) atom, tin (Sn) atom, or titanium (Ti) atom.

In one embodiment, R¹¹¹ to R¹¹⁴ are independently a group represented by —O—RA. In one embodiment, RA is a substituted or unsubstituted alkyl group having 1 to 50 carbon atoms in this case.

In one embodiment, some of R¹¹¹ to R¹¹⁴ are independently a group represented by —O—RA, and the other R¹¹¹ to R¹¹⁴ are independently a substituent RA. In one embodiment, RA is a substituted or unsubstituted alkyl group having 1 to 50 carbon atoms in this case. RA may have a substituent, and examples of the substituent include an acryloyl group, a methacryloyl group, a group represented by —N(R^{S1})(R^{S2}) (R^{S1} and R^{S2} are independently a hydrogen atom, an alkyl group having 1 to 50 carbon atoms, an alkenyl group having 2 to 50 carbon atoms, an alkynyl group having 2 to 50 carbon atoms, a cycloalkyl group having 3 to 50 ring carbon atoms, an aryl group having 6 to 50 ring carbon atoms, or a monovalent heterocyclic group having 5 to 50 ring atoms), and the like.

The number of carbon atoms of the above alkyl group may be, for example, 1 to 30, 1 to 20 or 1 to 15.

In one embodiment, RA or RA of the group represented by —O—RA is independently a substituted or unsubstituted alkyl group having 4 to 20 carbon atoms. In this case, the total number of carbon atoms of R¹¹¹ to R¹¹⁴ may be 12 to 60, 12 to 50, or 12 to 40.

In one embodiment, R¹¹¹ to R¹¹⁴ are independently a RA, and in this case, in one embodiment, some of R¹¹¹ to R¹¹⁴ are independently a substituted or unsubstituted alkyl group having 1 to 50 carbon atoms, and the other R¹¹¹ to R¹¹⁴ are independently a substituted or unsubstituted monovalent heterocyclic group having 5 to 50 ring atoms. The number of carbon atoms of the above alkyl group may be, for example, 1 to 30, 1 to 20, or 1 to 15 carbon atoms. The number of ring atoms of the monovalent heterocyclic group may be, for example, 5 to 50, 5 to 30, 5 to 20, or 5 to 10.

### (Compound Represented by Formula (12))

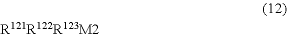

In the formula (12), R¹²¹ to R¹²³ are independently a hydrogen atom, a substituent RA, or a group represented by —O—RA, and at least one of R¹²¹ to R¹²³ is the substituent RA or the group represented by —O—RA. M2 is a trivalent atom.

In one embodiment, M2 is boron (B) atom, aluminum (Al) atom, scandium (Sc) atom, gallium (Ga) atom, yttrium (Y) atom, indium (In) atom, or gadolinium (Gd) atom, and it is, for example, boron (B) atom, or aluminum (Al) atom.

In one embodiment, RA in the formula (12) is independently a substituted or unsubstituted alkyl group having 1 to 50 carbon atoms. The number of carbon atoms may be, for example, 1 to 30, 1 to 20 or 1 to 15.

In one embodiment, RA in the formula (12) is independently a substituted or unsubstituted alkyl group having 4 to 20 carbon atoms. The total number of carbon atoms of R¹¹¹ to R¹¹⁴ may be 12 to 60, 12 to 50, or 12 to 40.

In one embodiment, R¹²¹ to R¹²³ are independently a group represented by —O—RA. In one embodiment, RA is a substituted or unsubstituted alkyl group having 1 to 50 carbon atoms.

### (Compound Represented by Formula (13))

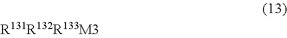

In the formula (13), R¹³¹ to R¹³³ are independently a hydrogen atom, a substituent RA, or a group represented by —O—RA, and at least one of R¹³¹ to R¹³³ is the substituent RA or the group represented by —O—RA. M3 is a trivalent organic group including a triazine skeleton.

In one embodiment, M3 is a trivalent organic group including a 2,4,6-trioxohexahydro-1,3,5-triazine structure.

In one embodiment, R¹³¹ to R¹³³ are independently a substituent RA, and RA is independently a substituted or unsubstituted alkyl group having 1 to 50 carbon atoms. The number of carbon atoms may be, for example, 1 to 30, 1 to 20, or 1 to 15.

RA may have a substituent, and in this case, examples of the substituent include a group represented by —Si(R^{S3})(R^{S4})(R^{S5}) (R^{s3} to R^{S5} are independently a hydrogen atom, an alkyl group having 1 to 50 carbon atoms, an alkoxy group having 1 to 50 carbon atoms, an alkenyl group having 2 to 50 carbon atoms, an alkynyl group having 2 to 50 carbon atoms, a cycloalkyl group having 3 to 50 ring carbon atoms, an aryl group having 6 to 50 ring carbon atoms, or a monovalent heterocyclic group having 5 to 50 ring atoms).

### (Compound Represented by Formula (14))

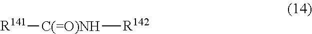

In the formula (14), R¹⁴¹ and R¹⁴² are independently a hydrogen atom, a substituent RA, or a group represented by —O—RA, and at least one of R¹⁴¹ and R¹⁴² is the substituent RA or the group represented by —O—RA.

In one embodiment, R¹⁴¹ and R¹⁴² are independently a substituent RA, and RA is independently a substituted or unsubstituted alkyl group having 1 to 50 carbon atoms. The number of carbon atoms may be, for example, 1 to 30, 1 to 20, or 1 to 15.

In one embodiment, R¹⁴¹ is a substituted or unsubstituted alkyl group having 1 to 50 carbon atoms, and the number of carbon atoms may be, for example, 5 to 20, or 10 to 20.

In one embodiment, R¹⁴² is a substituted or unsubstituted alkyl group having 1 to 50 carbon atoms, and the number of carbon atoms may be, for example, 1 to 10, or 1 to 5. Here, R¹⁴² may have a substituent, and in this case, examples of the substituent include a group represented by —N(R^{S1})(R^{S2}) (R^{S1} and R^{S2} are independently a hydrogen atom, an alkyl group having 1 to 50 carbon atoms, an alkenyl group having 2 to 50 carbon atoms, an alkynyl group having 2 to 50 carbon atoms, a cycloalkyl group having 3 to 50 ring carbon atoms, an aryl group having 6 to 50 ring carbon atoms, or a monovalent heterocycllic group having 5 to 50 ring atoms).

### (Compound Represented by Formula (15))

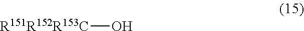

In the formula (15), R¹⁵¹ to R¹⁵³ are independently a hydrogen atom, a substituent RA, or a group represented by —O—RA, and at least one of R¹⁵¹ to R¹⁵³ is the substituent RA or the group represented by —O—RA.

In one embodiment, R¹⁵¹ is a substituent RA (for example, a substituted or unsubstituted alkyl group having 1 to 50 carbon atoms), R¹⁵² is a substituent RA (for example, a substituted or unsubstituted aryl group having 6 to 50 ring carbon atoms), and R¹⁵³ is a hydrogen atom. The number of carbon atoms of the above alkyl group may be, for example, 1 to 20, or 1 to 10.

In one embodiment, R¹⁵¹ is a substituent RA (for example, a substituted or unsubstituted alkyl group having 1 to 50 carbon atoms), R¹⁵² is a substituent RA (for example, a substituted or unsubstituted alkyl group having 1 to 50 carbon atoms), and R¹⁵³ is a hydrogen atom. The number of carbon atoms of the above alkyl group may be, for example, 5 to 20, or 5 to 10.

### (Compound Represented by Formula (16))

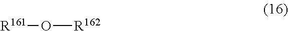

In the formula (16), R¹⁶¹ and R¹⁶² are independently a substituent RA.

In one embodiment, R¹⁶¹ is a substituent RA (for example, a substituted or unsubstituted alkyl group having 1 to 50 carbon atoms) and R¹⁶² is a substituent RA (for example, a substituted or unsubstituted aryl group having 6 to 50 ring carbon atoms). R¹⁶² may have the substituent, and examples of the substituent include a alkoxy group having 1 to 50 carbon atoms.

In one embodiment, the compound represented by the formula (16) is a compound containing two or more alkoxy groups having 1 to 50 carbon atoms in one molecule. In this instance, the two or more alkoxy groups having 1 to 50 carbon atoms may be the same as or different from each other. The number of carbon atoms of the alkoxy group may be, for example, 1 to 20, or 1 to 10.

(Compound represented by formula (17))

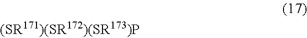

In the formula (17), R¹⁷¹ to R¹⁷³ are independently a hydrogen atom or a substituent RA, and at least one of R¹⁷¹ to R¹⁷³ is the substituent RA.

In one embodiment, R¹⁷¹ to R¹⁷³ are independently a substituted or unsubstituted alkyl group having 1 to 50 carbon atoms. The number of carbon atoms may be, for example, 1 to 30, 1 to 20 or 1 to 15.

In one embodiment, R¹⁷¹ to R¹⁷³ are independently a substituted or unsubstituted alkyl group having 4 to 20 carbon atoms. The total number of carbon atoms of R¹⁷¹ to R¹⁷³ may be 12 to 60, 12 to 50, or 12 to 40 carbon atoms.

As described above, all the compounds represented by the formulas (1) to (17) contributes greatly to the effect of the present invention, however in one embodiment, one or more compounds selected from the compounds represented by the formulas (1), (3), (5), (8), (10), (11), (12) and (14) to (16) are used as the component (B).

### (Solid Electrolyte Composition)

The solid electrolyte composition according to an aspect of the present invention may include the component (A) and the component (B), and there is no other particular limitation.

In one embodiment, the amount of the component (B) is 0.1 to 20% by mass based on the total amount of the component (A) and the component (B), and it may be 1 to 20% by mass, 2 to 15% by mass, or 3 to 10% by mass.

In one embodiment, the amount of each of the components (B) is more than 5% by volume, 10% by volume or more, 15% by volume or more, or 2θ% by volume or more, based on the entire solid electrolyte composition.

In one embodiment, the ionic conductivity of the above solid electrolyte composition is 1.5 mS/cm or greater, and it may be, for example, 2.0 mS/cm or greater, 3.0 mS/cm or greater, 4.0 mS/cm or greater, or 5.0 mS/cm or greater.

The ionic conductivity is measured by the method described in the Examples.

In one embodiment, the pellet density of the solid electrolyte composition measured by the particular condition may be 1.70 g/cm³ or higher, for example, 1.75 g/cm³ or higher, or 1.80 g/cm³ or higher.

The pellet density is measured by the method described in the Examples.

In one embodiment, in addition to the component (B), a compound represented by the following formula (X1) (hereinafter, sometimes referred to as component (Bα)) may be included therein.

R^{X1}R^{X2}R^{X3}PO (X1)

In the formula (X1), R^{X1} to R^{X3} are independently a hydrogen atom or a substituent RA, and at least one of R^{X1} to R^{X3} is the substituent RA. RA is as described above.

In one embodiment, R^{X1} to R^{X3} are independently a substituted or unsubstituted alkyl group having 1 to 50 carbon atoms. The number of carbon atoms may be, for example, 1 to 30, 1 to 20 or 1 to 15.

In one embodiment, R^{X1} to R^{X3} are independently a substituted or unsubstituted alkyl group having 4 to 20 carbon atoms. The total number of carbon atoms of R^{X1} to R^{X3} may be 12 to 60, 12 to 50, or 12 to 40.

The mass ratio of component (B) to component (Bα) is, for example, 1:9 to 9:1, or 2:8 to 8:2.

The solid electrolyte composition according to an aspect of the present invention may include (C) a solvent, may not substantially include it, or may not include it. The expression “not substantially include it” means, for example, a case in which a trace amount of a solvent is included so that the solvent is not completely removed even when the solvent removal operation is conducted. As the solvent, a known solvent can be used.

The solid electrolyte composition according to an aspect of the present invention may include (D) an electrode active material. The electrode active material will be described later.

In one embodiment, 80% by mass or more, 90% by mass or more, 95% by mass or more, 99% by mass or more, 99.5% by mass or more, 99.9% by mass or more, or 100% by mass of the solid electrolyte composition is
components (A) and (B),
components (A), (B), and (Bα)
components (A), (B) and (C),
components (A), (B), (Bα) and (C),
components (A), (B) and (D),
components (A), (B), (Bα) and (D),
components (A), (B), (C) and (D), or
components (A), (B), (Bα), (C) and (D).

In one embodiment, the amount of the compound having a molecular weight of 10,000 or less in all the components other than the component (A) in the solid electrolyte composition is 80% by mass or more, 90% by mass or more, 95% by mass or more, 99% by mass or more, 99.5% by mass or more, 99.9% by mass or more, or 100% by mass.

In one embodiment, the amount of the compound having a molecular weight of more than 10,000 in the solid electrolyte composition is 2θ% by mass or less, 10% by mass or less, 5% by mass or less, 1% by mass or less, 0.5% by mass or less, 0.1% by mass or less, or 0 mass.

The molecular weight of the high molecular weight component is the number-average molecular weight (Mn) determined by GPC (Gel Permeation Chromatography).

### 2. Solid Electrolyte Layer or Electrode Mixture

The solid electrolyte composition according to an aspect of the present invention can be used for a solid electrolyte layer, a positive electrode, a negative electrode, and the like in a lithium-ion secondary battery and the like.

### (Solid Electrolyte Layer)

A solid electrolyte layer according to an aspect of the present invention includes or is produced from the solid electrolyte composition described above.

The solid electrolyte layer may include only the solid electrolyte composition described above, or may be produced of only the solid electrolyte composition described above, or may further include a binder. The binder may be the same as the binder described in the negative electrode mixture described later.

Other configuration of the solid electrolyte layer described above is as described in the solid electrolyte layer of lithium-ion battery described later.

### (Electrode Mixture)

An electrode mixture according to an aspect of the present invention includes the solid electrolyte composition and the active material, or is produced of the composition including the solid electrolyte composition and the active material. When a negative electrode active material is used as the active material, a negative electrode mixture is formed, and when a positive electrode active material is used, a positive electrode mixture is formed.

### (Negative Electrode Mixture)

As a negative electrode active material used for a negative electrode mixture, for example, carbon material, metal material, or the like can be used. A complex composed of two or more of these can also be used. Further, a negative electrode active material that will be developed in the future can be used. It is preferable that the negative electrode active material have electron conductivity.

Example of the carbon material include graphite (e.g., artificial graphite), graphite carbon fiber, resin calcined carbon, pyrolytic vapor grown carbon, coke, mesocarbon microbeads (MCMB), calcined carbon of furfuryl alcohol resin, polyacene, pitch-based carbon fibers, vapor grown carbon fibers, natural graphite, non-graphitized carbon and the like.

Examples of the metal material include single-component metal, alloy, and metal compound. Examples of the single-component metal include metallic silicon, metallic tin, metallic lithium, metallic indium, and metallic aluminum. Examples of the alloy include an alloy including at least one member of silicon, tin, lithium, indium and aluminum. Examples of the metal compound include a metal oxide. The metal oxide is, for example, silicon oxide, tin oxide or aluminum oxide.

In one embodiment, the blending ratio of the negative electrode active material to the solid electrolyte composition is the negative electrode active material: the solid electrolyte composition (mass ratio)=95:5 to 5:95, 90:10 to 10:90, or 85:15 to 15:85.

The negative electrode mixture may further include a conductive aid. When the electron conductivity of the negative electrode active material is low, it is preferable to add a conductive aid. It is sufficient that the conductive aid has conductivity, and electron conductivity is preferably 1×10³ S/cm or more, and more preferably 1×10⁵ S/cm or more.

Specific examples of the conductive aid include a carbon material and a material containing at least one element selected from the group consisting of nickel, copper, aluminum, indium, silver, cobalt, magnesium, lithium, chromium, gold, ruthenium, platinum, beryllium, iridium, molybdenum, niobium, osmium, rhodium, tungsten and zinc, and more preferably elemental carbon having high conductivity or a carbon material other than elemental carbon; single-component metal, mixture or compound containing nickel, copper, silver, cobalt, magnesium, lithium, ruthenium, gold, platinum, niobium, osmium or rhodium.

Specific examples of the carbon material include carbon black such as Ketjen black, acetylene black, Denca black, thermal black and channel black; graphite, carbon fiber, activated carbon, and the like, and they can be used alone, or two or more kinds thereof can be used in combination. Among them, acetylene black, Denca black, and Ketjen black having high electron conductivity are preferable.

When the negative electrode mixture contains the conductive aid, the amount of the conductive aid in the mixture is preferably 1 to 40% by mass, and more preferably 2 to 20% by mass.

It may further include a binder in order to closely bind the negative electrode active material and the solid electrolyte composition to each other.

As the binder, a fluorine-containing resin such as polytetrafluoroethylene (PTFE), polyvinylidene fluoride (PVDF) and fluorine rubber; a thermoplastic resin such as polypropylene and polyethylene; ethylene-propylene-diene rubber (EPDM), sulfonated EPDM, natural butyl rubber (NBR), and the like can be used alone, or a mixture of two or more kinds thereof can be used. In addition, an aqueous dispersion of cellulose or styrene-butadiene rubber (SBR), which is an aqueous binder, can be also used.

The negative electrode mixture can be produced by mixing the solid electrolyte composition and the negative electrode active material, or the solid electrolyte composition, the negative electrode active material and an arbitrary conductive aid and/or the binder.

The mixing method is not specifically limited, and for example, dry mixing by using mortar, ball mill, beads mill, jet mill, planetary ball mill, vibrating ball mill, sand mill, or cutter mill; and wet mixing by dispersing the raw materials in organic solvent, by mixing using mortar, ball mill, beads mill, planetary ball mill, vibrating ball mill, sand mill, or FILMIX and then by removing the solvent, can be used. Among them, wet mixing is preferable in order not to destroy the negative electrode active material particle.

### (Positive Electrode Mixture)

The positive electrode active material used in the positive electrode mixture is a material capable of injection-desorption of lithium-ions. A known positive electrode active material can be used as the positive electrode active material in the field of battery. Further, a positive electrode active material to be developed in the future can also be used.

Examples of the positive electrode active material include metal oxide, sulfide, and the like. The sulfide includes metal sulfide and non-metal sulfide.

The metal oxide is, for example, a transition metal oxide. Specifically, examples thereof include V₂O₅, V₆O₁₃, LiCoO₂, LiNiO₂, LiMnO₂, LiMn₂O₄, Li(NiₐCo_{b}Mn_{c})O₂ (wherein 0<a<1, 0<b<1, 0<c<1, a+b+c=1), LiNi_{1-Y}Co_{Y}O₂, LiCo_{1-Y}Mn_{Y}O₂, LiNi_{1-Y}Mn_{Y}O₂ (wherein 0≤Y<1), Li(NiₐCo_{b}Mn_{c})O₄(0<a<2, 0<b<2, 0<c<2, a+b+c=2), LiMn_{2-Z}Ni_{Z}O₄, LiMn_{2-Z}Co_{Z}O₄ (wherein 0<Z<2), LiCoPO₄, LiFePO₄, CuO, Li(NiₐCo_{b}Al_{c})O₂ (wherein 0<a<1, 0<b<1, 0<c<1, a+b+c=1), and the like. Examples of the metal sulfide include titanium sulfide (TiS₂), molybdenum sulfide (MoS₂), iron sulfide (FeS, FeS₂), copper sulfide (CuS) and nickel sulfide (Ni₃S₂). Examples of the metal oxide include bismuth oxide (Bi₂O₃), bismuth plumbate (Bi₂Pb₂O₅), and the like.

Examples of non-metallic sulfide include organic disulfide compound, carbon sulfide compound, and the like.

In addition to those mentioned above, niobium selenide (NbSe₃), metal indium, and sulfur can also be used as the positive electrode active material.

The positive electrode mixture may further include a conductive aid. The conductive aid is the same as that described for the negative electrode mixture.

The blending ratio of the solid electrolyte composition and the positive electrode active material in the positive electrode mixture is the same as the blending ratio of the solid electrolyte composition and the negative electrode active material described above. The amount of the conductive aid in the positive electrode mixture is the same as the amount of the conductive aid in the negative electrode mixture described above. The method for preparing the positive electrode mixture is the same as the method for preparing the negative electrode mixture described above.

### 3. Lithium-Ion Battery

A lithium-ion battery (first lithium-ion battery) according to an aspect of the present invention includes one or more members selected from the group consisting of the solid electrolyte layer, the negative electrode mixture and the positive electrode mixture described above, or includes one or more members selected from the group consisting of the solid electrolyte layer, the negative electrode layer produced of the negative electrode mixture described above, and the positive electrode layer produced of the positive electrode mixture described above.

The lithium-ion battery generally has a configuration in which a negative electrode layer, an electrolyte layer, and a positive electrode layer are stacked in this order.

### (Negative Electrode Layer)

When the negative electrode mixture according to an aspect of the present invention is used as a negative electrode layer, the negative electrode mixture is as described above. When a material other than the negative electrode mixture according to an aspect of the present invention is used as the negative electrode layer, a known configuration may be employed.

The negative electrode layer has, for example, a thickness of 100 nm or more and 5 mm or less, 1 μm or more and 3 mm or less, or 5 μm or more and 1 mm or less.

The negative electrode layer can be produced by a known method, for example, can be produced by a coating method and an electrostatic method (an electrostatic spray method, an electrostatic screen method, and the like).

(Electrolyte layer)

When the solid electrolyte layer according to an aspect of the present invention is used as the electrolyte layer, the solid electrolyte layer is as described above. When a layer other than the solid electrolyte layer according to an aspect of the present invention is used as the electrolyte layer, a known configuration may be employed.

The electrolyte layer has, for example, a thickness of 0.001 mm or more and 1 mm or less.

The solid electrolyte of the electrolyte layer may be fusion. Fusion means that a part of the solid electrolyte particles dissolve and the dissolved part integrates with other solid electrolyte particles. Further, the electrolyte layer may be a plate-like body of the solid electrolyte, and as for the plate-like body, there may be cases where part or all of the solid electrolyte particles are dissolved to form a plate-like body.

The electrolyte layer can be produced by a known method, and it can be produced by, for example, a coating method or an electrostatic method (an electrostatic spray method, an electrostatic screen method, and the like).

### (Positive Electrode Layer)

When the positive electrode mixture according to an aspect of the present invention is used as a positive electrode layer, the positive electrode mixture is as described above. When a material other than the positive electrode mixture according to an aspect of the present invention is used as the positive electrode layer, a known configuration may be employed.

The positive electrode layer has, for example, a thickness of 0.01 mm or more and 10 mm or less.

The positive electrode layer can be produced by a known method, and it can be produced by, for example, a coating method, an electrostatic method (an electrostatic spray method, an electrostatic screen method, and the like).

### (Current Collector)

In one embodiment, the lithium-ion battery includes a current collector. For example, a negative electrode current collector is provided on the negative electrode layer in the opposite side of the electrolyte layer, and a positive electrode current collector is provided on the electrolyte layer in the opposite side of the positive electrode layer.

As the current collector, a plate-like body, a foil-like body or the like made of copper, magnesium, stainless steel, titanium, iron, cobalt, nickel, zinc, aluminium, germanium, indium, lithium, an alloy thereof, or the like can be used.

The above-described lithium-ion battery can be produced by pasting and bonding the above-described members. As a method of bonding, there are a method of stacking each member, pressing and crimping the members, a method of pressing through between two rolls (roll to roll), and the like. It may be bonding with an active material having an ionic conductivity or an adhesive material that does not impair ionic conductivity on the bonding surface. In bonding, it may heat and fuse them within a range that does not alter the crystalline structure of the solid electrolyte.

The above-described lithium-ion battery can also be produced by sequentially forming the above-described members. It can be produced by a known method, and it can be produced by, for example, a coating method, an electrostatic method (an electrostatic spray method, an electrostatic screen method, and the like).

In a lithium-ion battery (second lithium-ion battery) according to other aspect of the present invention, at least one of the electrodes (the negative electrode layer and the positive electrode layer) and the solid electrolyte layer includes the following component (A) and component (B).
(A) a sulfide solid electrolyte including lithium, phosphorus and sulfur
(B) one or more compounds selected from the compounds represented by the formulas (1) to (17)

The component (A) and component (B) are as described for the solid electrolyte composition according to an aspect of the present invention.

The second lithium-ion battery is the same as the first lithium-ion battery except that the phrase “the first lithium-ion battery includes one or more members selected from the group consisting of the solid electrolyte layer, the negative electrode mixture and the positive electrode mixture described above, or includes one or more members selected from the group consisting of the solid electrolyte layer, the negative electrode layer produced of the negative electrode mixture described above, and the positive electrode layer produced of the positive electrode mixture described above” is replaced with the phrase “at least one of the electrode and the solid electrolyte layer includes the following component (A) and component (B)”, and each configuration can be applied as appropriate.

When each layer in the second lithium-ion battery includes the component (A) and the component (B), the amount ratio of the component (A) and the component (B) is as described in the solid electrolyte composition according to an aspect of the present invention.

### EXAMPLES

The present invention is described below in more detail by Examples.

The component (B) used in the following Examples and component (B′) (component corresponding to the component (B)) used in the Comparative Examples are as follows. The alphabetical notation used together is the abbreviation for each compound.

B1: Tri-n-octylphosphine (TOP)
B2: Triphenylphosphine (TPP)
B3: Dodecanethiol (DT)
B4: Tris(diethylamino)phosphine (HDEPT)
B5: Oleic acid (OAC)
B6: Oleylamine (OAM)
B7: Tri-n-octylphosphine sulfide (TOPS)
B8: Tridodecylamine (TDA)
B9: Trioctylamine (TOA)
B10: Poly(oxyethylene) dodecyl ether (n=4, SAA1, “Brij (registered trademark) L4” manufactured by Sigma-Aldrich Co. LLC)
B11: Poly(oxyethylene) octadecyl ether (n=1 to 2, SAA2, “Brij (registered trademark) 93” manufactured by Sigma-Aldrich Co. LLC)
B12: Tris(2-ethylhexyl)phosphite (2EHPhi)
B13: Tetrakis(2-ethylhexyl)orthosilicate (T2EOS)
B14: Tetrakis(2-ethylhexyl)orthotitanate (T2EOTi)
B15: Triethoxy(3-methacryloyloxypropyl)silane (MCTMS)
B16: Octyl-n-borate (TOB)
B17: Trioctadecyl borate (TOctaB)
B18: Aluminum sec-butoxide (ButAl)
B19: 3-Aminopropyltriethoxysilane (AmTMS)
B2θ: Octadecyltriethoxysilane (TEOcS)
B21: Methoxy(dimethyl)octadecylsilane (MDMOcS)
B22:2,4,6-Trioxohexahydro-1,3,5-triazine-1,3,5-tris(propyltrimethoxysilane) (ICyTMS)
B23: N-[2-(Diethylamino)ethyl]octadecaneamide (N2STE)
B24: α-Pentylbenzyl alcohol (PBAI)
B25: 7-Tetradecanol (7TDNI)
B26: 9-Heptadecanol (9HDNI)
B27: Resorcinol diethyl ether (RDE)
B28: Allyl nonanate (NAAE)
B29: 2-(Tributylstannyl)thiazole (2TBST)
B30: Tridodecylphosphonotrithioate (TDPT)
B′1: Triethyl phosphate (TEPho)
B′2: Polyethylene oxide (n=about 22,500, PEO1, “372781” manufactured by Sigma-Aldrich Co. LLC)
B′3: Polyethylene oxide (n=about 9,000, PEO2, “372773” manufactured by Sigma-Aldrich Co. LLC)
B′4: Polyethylene oxide (n=about 2,250, PEO3, “181986” manufactured by Sigma-Aldrich Co. LLC)
B′5: Polyethylene glycol (n=about 225, PEG1, “309028” manufactured by Sigma-Aldrich Co. LLC)
B′6: Polyethylene glycol (n=about 75, PEG2, “202444” manufactured by Sigma-Aldrich Co. LLC)
B′7: Polyethylene glycol (n=about 9, PEG3, “202398” manufactured by Sigma-Aldrich Co. LLC)

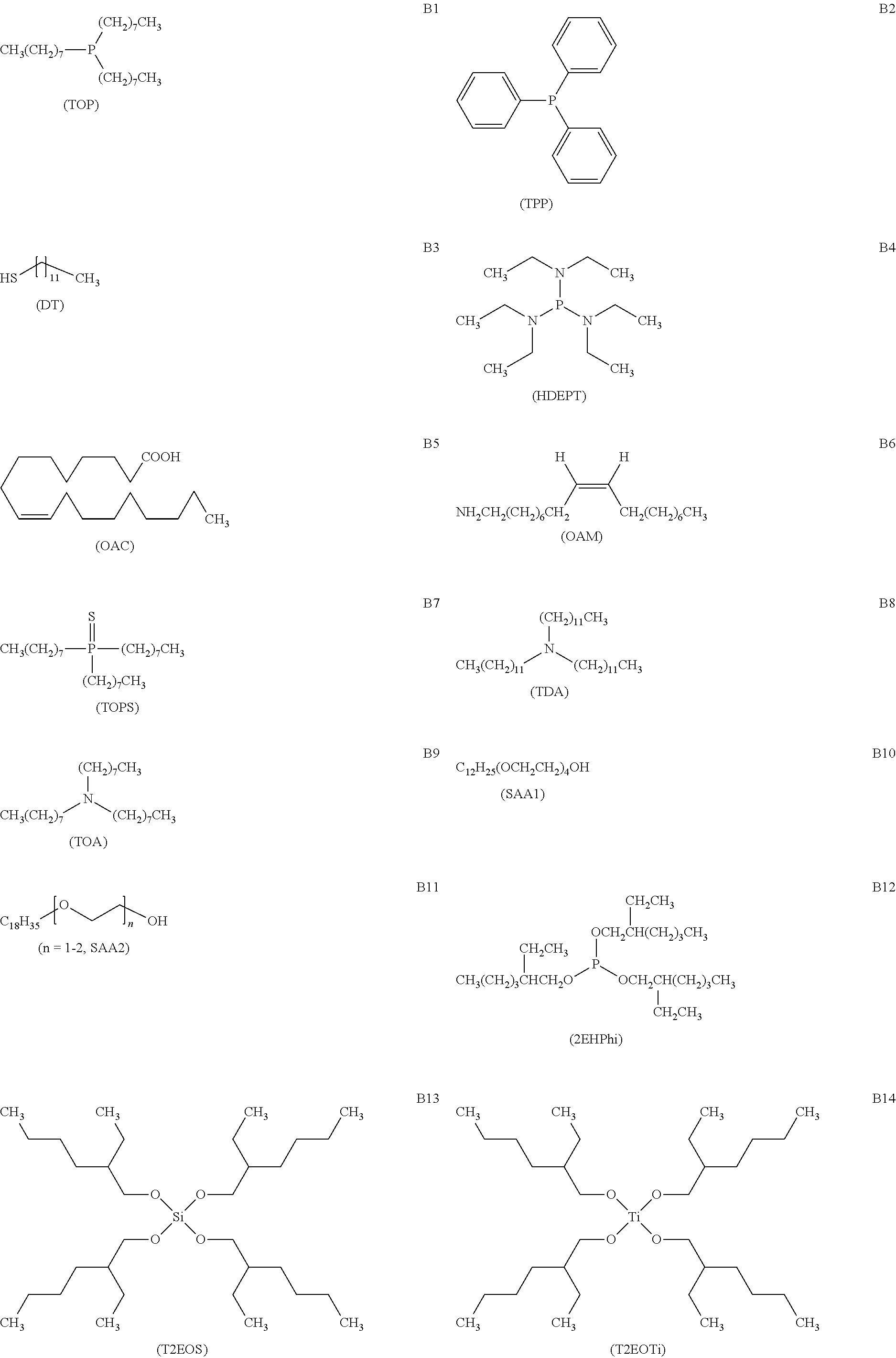

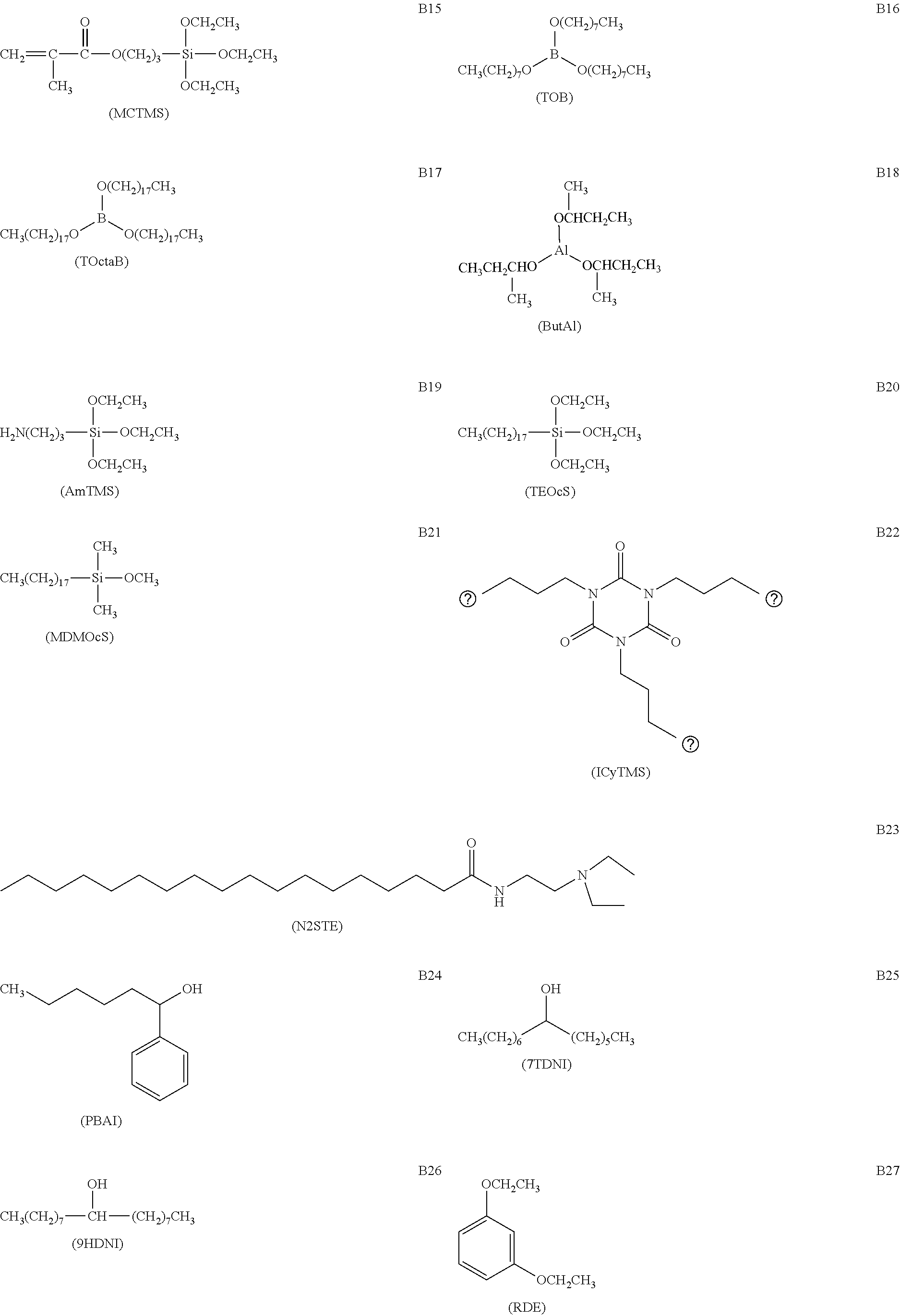

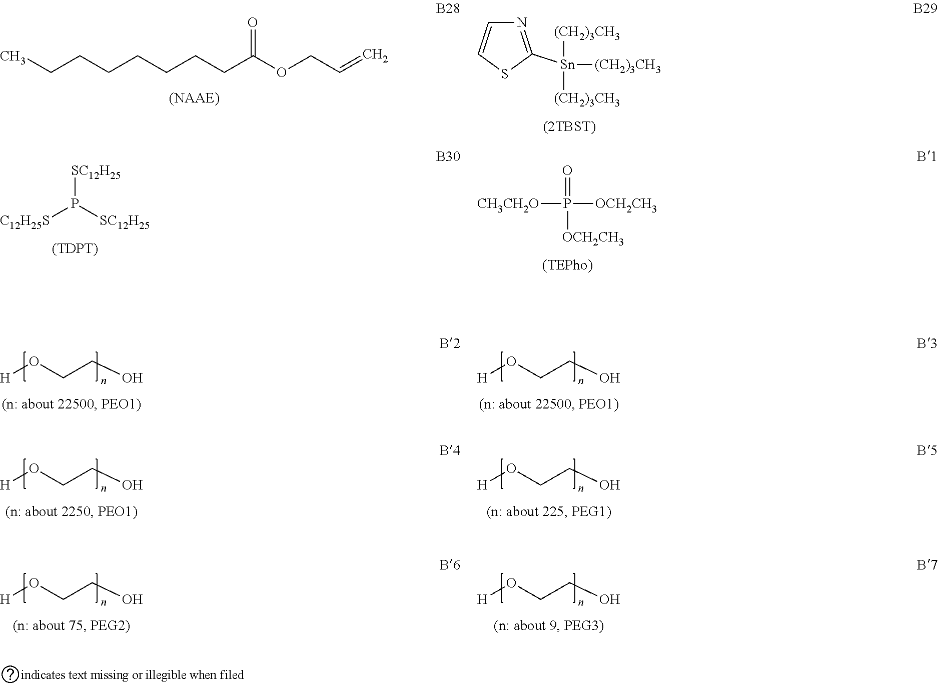

Each evaluation method in Examples and Comparative Examples is as follows.

### (1) Ionic Conductivity

A sample of a solid electrolyte or a solid electrolyte composition was loaded into a tablet press, and it was pressurized with 400 MPa to form a molded body (also referred to as “pellet”, about 10 mm in diameter, about 0.1 to 0.2 cm in thickness). Carbons were arranged on both sides of the molded body as an electrode, and it was pressurized again by the tablet press to form a molded body for measurement. The ionic conductivity was measured by AC impedance measurement on the molded body for measurement. A value at 25° C. was used as the conductivity value thereof.

### (2) Changing Rate of Ionic Conductivity

The degree of change in ionic conductivity was measured due to the addition of component (B). Specifically, in Examples 1 to 20 and 22 to 33 and Comparative Examples 2 to 8, the changing rate of the ionic conductivity was calculated based on the ionic conductivity in Comparative Example 1 using the same component (A) alone. In Example 21, the changing rate of the ionic conductivity was calculated based on the ionic conductivity in Comparative Example 9 using the same component (A) alone.

### (3) Pellet Density

The pellet density was calculated from the weight and thickness of the pellet formed in “(1) Ionic conductivity”.

### (4) Changing Rate (Increasing Rate) of Pellet Density

The degree of change in pellet density was measured due to the addition of component (B). Specifically, in Examples 1 to 20 and 22 to 33 and Comparative Examples 2 to 8, the changing rate (increasing rate) of the pellet density was calculated based on the pellet density in Comparative Example 1 using the same component (A) alone. In Example 21, the changing rate (increasing rate) of the ionic conductivity was calculated based on the ionic conductivity in Comparative Example 9 using the same component (A) alone.

### (5) Changing Rate of Ionic Conductivity Per 1% of Increasing Rate of Pellet Density

The changing rate of the ionic conductivity per unit changing rate of the pellet density was obtained by dividing the changing rate of the ionic conductivity obtained by “(2) Changing rate of ionic conductivity” by the increasing rate of the pellet density obtained by “(4) Increasing rate of pellet density”.

### Preparation 1 (Preparation of Component (A): Argyrodite Type Solid Electrolyte (Sulfide Solid Electrolyte))

### (A) Preparation of Raw Material Mixture

In a nitrogen atmosphere glove box, each ground compound was weighed to have a molar proportion of Li₂S:P₂S₅:LiBr:LiCl=47.5:12.5:15.0:25.0, and then they were added to a glass vessel, and the vessel was shaken to crude mixing them.

The crude mixed raw material was dispersed in a mixed solvent of dehydrated toluene (manufactured by FUJIFILM Wako Pure Chemical Corporation) and dehydrated isobutyronitrile (manufactured by KISHIDA CHEMICAL Co., Ltd.) in a nitrogen atmosphere to obtain a raw material mixture slurry of about 10% by mass. The raw material mixture slurry was mixed and pulverized using a beads mill (LMZ015, manufactured by Ashizawa Finetech Ltd.) while maintaining the slurry in a nitrogen atmosphere. The treated slurry was added to a nitrogen-substituted Schlenk bottle, and then it was dried under reduced pressure to prepare a raw material mixture.

### (B) Firing Step

The raw material mixture obtained in the above (A) was heated in an electric furnace (F-1404-A, manufactured by Tokyo Garasu Kikai Co., Ltd.) under the nitrogen atmosphere. Specifically, the raw material mixture was added to a saggar made of Al₂O₃ (999-60S, manufactured by Tokyo Garasu Kikai Co., Ltd.), and then it was subjected to heat treatment at 430° C. for an hour or more in the electric furnace. Thereafter, the saggar was taken out of the electric furnace and slowly cooled to obtain an argyrodite type solid electrolyte.

### (C) Finely Pulverizing Step

The obtained argyrodite type solid electrolyte was dispersed in a mixed solvent of dehydrated toluene (manufactured by FUJIFILM Wako Pure Chemical Corporation) and dehydrated isobutyronitrile (manufactured by KISHIDA CHEMICAL Co., Ltd.) to form a solid electrolyte slurry under the nitrogen atmosphere. The slurry was mixed and pulverized using a beads mill (LMZ015, manufactured by Ashizawa Finetech Ltd.) while maintaining the slurry under a nitrogen atmosphere. After the treatment, a solid electrolyte slurry was added to a nitrogen-substituted Schlenk bottle, and then it was dried under reduced pressure to obtain a particulate argyrodite type solid electrolyte (component (A): hereinafter also referred to as “A1”).

As a result of X-ray diffraction (XRD) measurement, peaks derived from an argyrodite type crystal structure was observed at 2θ=25.5±1.0 deg, 29.9±1.0 deg and the like in the XRD patterns.

Preparation 2 (Component (A): Preparation of Solid Electrolyte (Sulfide Solid Electrolyte) with Thio-LISICON Region II Type Crystalline Structure)

0.59 g of lithium sulfide, 0.95 g of phosphorus pentasulfide, 0.19 g of lithium bromide, and 0.28 g of lithium iodide were added to a Schlenk bottle (volume: 100 mL) with a stirrer bar under a nitrogen atmosphere. After rotating the stirrer, 20 mL of tetramethylethylenediamine (TMEDA) was added as a complexing agent, it was left stirring for 12 hours, and a resulting complex-containing product was dried in a vacuum (room temperature: 23° C.) to obtain a powdered complex. Subsequently, the complex powder was heated in a vacuum at 120° C. for two hours to obtain an amorphous sulfide solid electrolyte. Further, the amorphous sulfide solid electrolyte was heated at 140° C. in a vacuum for two hours to obtain a crystalline sulfide solid electrolyte A2.

### Example 1 (Preparation and Evaluation of Solid Electrolyte Composition)

A1 and B1 (TOP) in which the total amount thereof was 1.5 g so that the amount of B1 was 10% by mass based on the total amount of A1 and B1, and 15.5 mL of toluene were added to a 50 mL of Schlenk tube with a stirrer tip under a nitrogen atmosphere to prepare a mixture (slurry). It was stirred at 60° C. for an hour while maintaining the nitrogen atmosphere. Thereafter, it was dried in a vacuum at room temperature until roughly dry powder, and then it was dried in a vacuum at 80° C. for an hour to obtain a powder of solid electrolyte composition. The evaluation results of the obtained solid electrolyte composition are shown in Table1.

The volume amount (% by volume) of B1 is also shown in Table 1 based on the total volume amount of A1 and B1 (the same also applies to the following Examples and Comparative Examples).

### Example 2

A solid electrolyte composition was prepared and evaluated in the same manner as in Example 1, except that B1 (TOP) was used as the component (B) and tri-n-octylphosphine oxide (TOPO) was further added. The results are shown in Table 1. The amount of B1 (TOP) and the amount of TOPO were independently 5% by mass based on the total amount of A1, B1 and TOPO.

### Example 3

A solid electrolyte composition was prepared and evaluated in the same manner as in Example 1, except that the amount of B1 was 7% by mass based on the total amount of A1, B1 and TOPO, and the amount of TOPO was 3% by mass based on the total amount of A1, B1 and TOPO. The results are shown in Table 1.

### Examples 4 to 20 and 22 to 33

Solid electrolyte compositions were prepared and evaluated in the same manner as in Example 1, except that the component (B) shown in Table 1 was used instead of B1. The results are shown in Tables 1 and 2.

### Example 21

A2 was used instead of A1, and A2 and B1 (TOP) in which the total amount thereof was 3.3 g so that the amount of B1 was 9.1% by mass based on the total amount of A2 and B1, and 25 mL of toluene were added to prepare a mixture (slurry). It was stirred for 10 minutes while maintaining the nitrogen atmosphere, and then the toluene was distilled off by drying in a vacuum to obtain a powder of solid electrolyte. The evaluation results of the obtained solid electrolyte composition are shown in Table1.

### Comparative Example 1

A solid electrolyte composition was prepared and evaluated in the same manner as in Example 1, except that the component (B) was not used. The results are shown in Table 3.

### Comparative Examples 2 to 8

A solid electrolyte composition was prepared and evaluated in the same manner as in Example 1, except that the components (B′) shown in Table 2 were used instead of B1. The results are shown in Table 3.

### Comparative Example 9

A solid electrolyte composition was prepared and evaluated in the same manner as in Example 21, except that the component (B) was not used. The results are shown in Table 3.

TABLE 1

| | | | | | Evaluation of solid electrolyte composition | | | | |
|---|---|---|---|---|---|---|---|---|---|
| | | | | | | | | Increasing | Changing rate of |
| | | Component (B) | | | | Changing rate | | rate of | ionic conductivity |
| | | | Amount | Amount | Ionic | of ionic | Pellet | pellet | per 1% of increasing |
| | | | (% by | (% by | conductivity | conductivity | density | density | rate of pellet |
| | Component (A) | Compound | mass) | volume) | (mS/cm) | (%) | (g/cm³) | (%) | density (%) |
| Example 1 | Argyrodite type | B1(TOP) | 10 | 21.3 | 5.08 | −18.4 | 1.82 | 10.4 | −1.8 |
| Example 2 | Argyrodite type | B1(TOP) + TOPO | 10(5 + 5) | 20.8 | 4.17 | −33.0 | 1.78 | 7.7 | −4.3 |
| Example 3 | Argyrodite type | B1(TOP) + TOPO | 10(7 + 3) | 21.0 | 4.34 | −30.3 | 1.81 | 9.8 | −3.1 |
| Example 4 | Argyrodite type | B2(TPP) | 10 | 16.5 | 4.11 | −34.0 | 1.72 | 4.4 | −7.7 |
| Example 5 | Argyrodite type | B3(DT) | 10 | 21.0 | 5.38 | −13.6 | 1.87 | 13.4 | −1.0 |
| Example 6 | Argyrodite type | B4(HDEPT) | 10 | 20.0 | 3.84 | −38.3 | 1.80 | 8.9 | −4.3 |
| Example 7 | Argyrodite type | B5(OAC) | 10 | 20.1 | 3.72 | −40.3 | 1.74 | 5.5 | −7.4 |
| Example 8 | Argyrodite type | B6(OAM) | 10 | 21.3 | 3.12 | −49.9 | 1.76 | 6.5 | −7.6 |
| Example 9 | Argyrodite type | B7(TOPS) | 10 | 20.3 | 5.37 | −13.8 | 1.82 | 9.9 | −1.4 |
| Example 10 | Argyrodite type | B8(TDA) | 10 | 21.3 | 5.26 | −15.5 | 1.80 | 9.0 | −1.7 |
| Example 11 | Argyrodite type | B9(TOA) | 10 | 21.7 | 5.74 | −7.9 | 1.86 | 12.6 | −0.6 |
| Example 12 | Argyrodite type | B10(SAA1) | 10 | 19.1 | 1.87 | −70.0 | 1.78 | 7.6 | −9.2 |
| Example 13 | Argyrodite type | B11(SAA2) | 10 | 19.7 | 2.16 | −65.4 | 1.78 | 7.7 | −8.5 |
| Example 14 | Argyrodite type | B12(2EHPhi) | 10 | 18.9 | 3.89 | −37.5 | 1.83 | 10.7 | −3.5 |
| Example 15 | Argyrodite type | B13(T2EOS) | 10 | 20.3 | 5.64 | −9.5 | 1.81 | 9.6 | −1.0 |
| Example 16 | Argyrodite type | B14(T2EOTi) | 10 | 19.4 | 5.84 | −6.3 | 1.80 | 9.0 | −0.7 |
| Example 17 | Argyrodite type | B15(MCTMS) | 10 | 18.5 | 3.88 | −37.7 | 1.84 | 11.6 | −3.2 |
| Example 18 | Argyrodite type | B16(TOB) | 10 | 20.7 | 5.69 | −8.7 | 1.78 | 8.1 | −1.1 |
| Example 19 | Argyrodite type | B17(TOctaB) | 10 | 20.0 | 3.75 | −39.7 | 1.76 | 6.5 | −6.1 |
| Example 20 | Argyrodite type | B18(ButAl) | 10 | 18.8 | 2.39 | −61.6 | 1.77 | 7.2 | −8.6 |
| Example 21 | thio-LISICON | B1(TOP) | 9.1 | 19.6 | 3.11 | −16.7 | 1.86 | 5.2 | −3.2 |
| | Region II type | | | | | | | | |

TABLE 2

| | | | | | Evaluation of solid electrolyte composition | | | | |
|---|---|---|---|---|---|---|---|---|---|
| | | | | | | | | Increasing | Changing rate of |
| | | Component (B) | | | | Changing rate | | rate of | ionic conductivity |
| | | | Amount | Amount | Ionic | of ionic | Pellet | pellet | per 1% of increasing |
| | | | (% by | (% by | conductivity | conductivity | density | density | rate of pellet |
| | Component (A) | Compound | mass) | volume) | (mS/cm) | (%) | (g/cm³) | (%) | density (%) |
| Example 22 | Argyrodite type | B19(AmTMS) | 10 | 19.1 | 2.38 | −61.8 | 1.82 | 10.5 | −5.9 |
| Example 23 | Argyrodite type | B20(TEOcS) | 10 | 20.5 | 4.73 | −24.0 | 1.81 | 9.8 | −2.4 |
| Example 24 | Argyrodite type | B21(MDMOcS) | 10 | 21.3 | 5.36 | −13.9 | 1.81 | 9.7 | −1.4 |
| Example 25 | Argyrodite type | B22(ICyTMS) | 10 | 16.0 | 2.31 | −63.0 | 1.81 | 9.6 | −6.5 |
| Example 26 | Argyrodite type | B23(N2STE) | 10 | 20.5 | 3.18 | −48.9 | 1.77 | 7.2 | −6.8 |
| Example 27 | Argyrodite type | B24(PBAI) | 10 | 19.1 | 4.08 | −34.5 | 1.79 | 8.4 | −4.1 |
| Example 28 | Argyrodite type | B25(7TDNI) | 10 | 21.3 | 4.36 | −30.0 | 1.79 | 8.4 | −3.6 |
| Example 29 | Argyrodite type | B26(9HDNI) | 10 | 21.1 | 4.26 | −31.6 | 1.74 | 5.4 | −5.9 |
| Example 30 | Argyrodite type | B27(RDE) | 10 | 18.2 | 4.79 | −23.1 | 1.84 | 11.4 | −2.0 |
| Example 31 | Argyrodite type | B28(NAAE) | 10 | 20.3 | 5.28 | −15.2 | 1.78 | 7.8 | −1.9 |
| Example 32 | Argyrodite type | B29(2TBST) | 10 | 15.9 | 5.06 | −18.7 | 1.86 | 12.7 | −1.5 |
| Example 33 | Argyrodite type | B30(TDPT) | 10 | 19.6 | 5.02 | −19.4 | 1.81 | 9.6 | −2.0 |

TABLE 3

| | | | | | Evaluation of solid electrolyte composition | | | | |
|---|---|---|---|---|---|---|---|---|---|
| | | | | | | | | Increasing | Changing rate of |
| | | Component (B′) | | | | Changing rate | | rate of | ionic conductivity |
| | | | Amount | Amount | Ionic | of ionic | Pellet | pellet | per 1% of increasing |
| | | | (% by | (% by | conductivity | conductivity | density | density | rate of pellet |
| | Component (A) | Compound | mass) | volume) | (mS/cm) | (%) | (g/cm³) | (%) | density (%) |
| Comparative | Argyrodite type | — | | | 6.23 | — | 1.65 | — | — |
| Example 1 | | | | | | | | | |
| Comparative | Argyrodite type | B′1(TEPho) | 10 | 17.3 | 1.38 | −77.9 | 1.77 | 6.9 | −11.3 |
| Example 2 | | | | | | | | | |
| Comparative | Argyrodite type | B′2(PEO1) | 10 | 16.6 | 0.07 | −98.8 | 1.64 | −1.0 | — |
| Example 3 | | | | | | | | | |
| Comparative | Argyrodite type | B′3(PEO2) | 10 | 16.6 | 0.09 | −98.6 | 1.67 | 0.9 | −108.6 |
| Example 4 | | | | | | | | | |
| Comparative | Argyrodite type | B′4(PEO3) | 10 | 16.6 | 0.18 | −97.2 | 1.64 | −0.7 | — |
| Example 5 | | | | | | | | | |
| Comparative | Argyrodite type | B′5(PEG1) | 10 | 17.3 | 0.24 | −96.1 | 1.65 | −0.3 | — |
| Example 6 | | | | | | | | | |
| Comparative | Argyrodite type | B′6(PEG2) | 10 | 15.7 | 0.48 | −92.2 | 1.66 | 0.4 | −253.8 |
| Example 7 | | | | | | | | | |
| Comparative | Argyrodite type | B′7(PEG3) | 10 | 16.6 | 0.61 | −90.2 | 1.63 | −1.4 | — |
| Example 8 | | | | | | | | | |
| Comparative | thio-LISICON | — | | | 3.73 | — | 1.77 | — | — |
| Example 9 | Region II type | | | | | | | | |

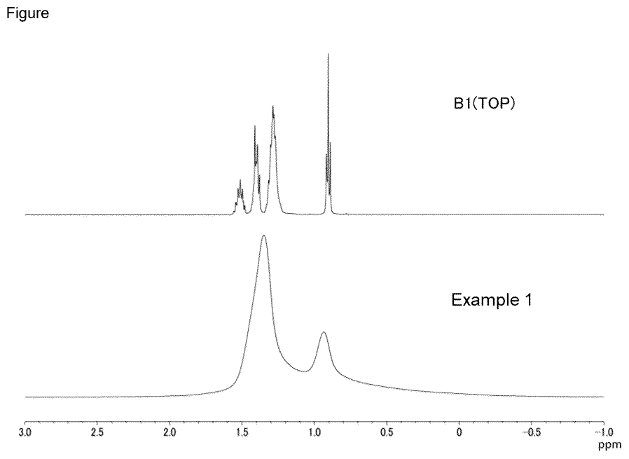

(1) All the pellet density results in Examples 1 to 20 and 22 to 33 were higher than that in Comparative Example 1. It was found that by adding the component (B) to the component (A), the density thereof can be increased as compared to that in the case where the component (A) was used alone. Here, as seen from the data of the amount (% by mass) and the amount (% by volume), all of the components (B) were a compound whose density is lower than that of the component (A), but the entire density was improved by the addition of the component (B), that is, it means that the amount of the solid electrolyte composition per unit pellet volume was increased and a dense solid electrolyte (solid electrolyte composition) with less voids is obtained. It is considered to be due to the results that the component (B) having a particular structure was used to improve the slipperiness between the particles of the component (A) (solid electrolyte) and to promote the rearrangement of the particles. As seen from the comparison between Example 21 and Comparative Example 9, the same was found.
(2) The results of the solid electrolyte composition of Example 1 and B1 (TOP) (which was in solution state when used alone) measured by ¹H-NMR are shown in FIG. 1. As seen from FIG. 1, the spectrum of Example 1 has a wide half-value width as compared to that of the spectrum of B1 (TOP). It is considered that the results were caused by the adsorption of the component (B) to the surface of the component (A) to decrease the molecular mobility of the component (B). The data also teach that the surface of component (A) was modified by the component (B).
(3) When the component (B) being an organic material was used, it was inevitable that the ionic conductivity decreased as compared to that in the case where the component (A) was used alone, but in Examples 1 to 33 in which the component (B) having the particular structure was used, it was found that the decrease was suppressed to be small, and the high ionic conductivity was able to be maintained. On the other hand, in Comparative Example 2 using triethyl phosphate (TEPho), it was found that a significant decrease in ionic conductivity occurred.
(4) In Comparative Examples 3 to 8, the performance of polyethylene oxide or polyethylene glycol was confirmed, but the effect of improving the pellet density was not confirmed, and further, the decrease in the ionic conductivity was even greater than that in Comparative Example 2.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1: A solid electrolyte composition comprising
(A) a sulfide solid electrolyte comprising lithium, phosphorus and sulfur, and
(B) one or more compounds selected from compounds represented by the following formulas (1) to (17): 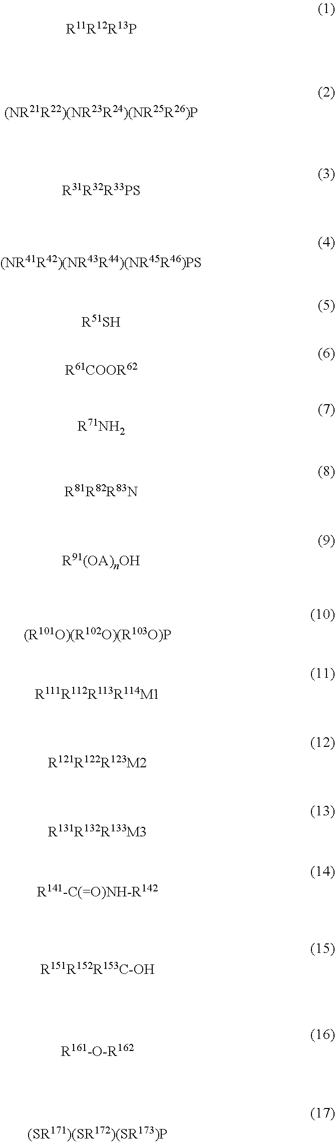
wherein in the formula (1), R¹¹ to R¹³ are independently a hydrogen atom or a substituent RA, and at least one of R¹¹ to R¹³ is the substituent RA;
in the formula (2), R²¹ to R²⁶ are independently a hydrogen atom or a substituent RA, and at least one of R²¹ to R²⁶ is the substituent RA;
in the formula (3), R³¹ to R³³ are independently a hydrogen atom or a substituent RA, and at least one of R³¹ to R³³ is the substituent RA;
in the formula (4), R⁴¹ to R⁴⁶ are independently a hydrogen atom or a substituent RA, and at least one of R⁴¹ to R⁴⁶ is the substituent RA;
in the formula (5), R⁵¹ is a substituent RA;
in the formula (6), R⁶¹ is a substituent RA, and R⁶² is a hydrogen atom or a substituent RA;
in the formula (7), R⁷¹ is a substituent RA;
in the formula (8), R⁸¹ to R⁸³ are independently a hydrogen atom or a substituent RA, and at least one of R⁸¹ to R⁸³ is the substituent RA;
in the formula (9), R⁹¹ is a substituent RA, and A is an alkylene group having 2 to 4 carbon atoms; n is 1 to 20;
in the formula (10), R¹⁰¹ to R¹⁰³ are independently a hydrogen atom or a substituent RA, and at least one of R¹⁰¹ to R¹⁰³ is the substituent RA;
in the formula (11), R¹¹¹ to R¹¹⁴ are independently a hydrogen atom, a substituent RA, or a group represented by —O—RA, and at least one of R¹¹¹ to R¹¹⁴ is the substituent RA or the group represented by —O—RA; M1 is a tetravalent atom;
in the formula (12), R¹²¹ to R¹²³ are independently a hydrogen atom, a substituent RA, or a group represented by —O—RA, and at least one of R¹²¹ to R¹²³ is the substituent RA or the group represented by —O—RA; M2 is a trivalent atom;
in the formula (13), R¹³¹ to R¹³³ are independently a hydrogen atom, a substituent RA, or a group represented by —O—RA, and at least one of R¹³¹ to R¹³³ is the substituent RA or the group represented by —O—RA; M3 is a trivalent organic group including a triazine skeleton;
in the formula (14), R¹⁴¹ and R¹⁴² are independently a hydrogen atom, a substituent RA, or a group represented by —O—RA, and at least one of R¹⁴¹ and R¹⁴² is the substituent RA or the group represented by —O—RA;
in the formula (15), R¹⁵¹ to R¹⁵³ are independently a hydrogen atom, a substituent RA, or a group represented by —O—RA, and at least one of R¹⁵¹ to R¹⁵³ is the substituent RA or the group represented by —O—RA;
in the formula (16), R¹⁶¹ and R¹⁶² are independently a substituent RA;
in the formula (17), R¹⁷¹ to R¹⁷³ are independently a hydrogen atom or a substituent RA, and at least one of R¹⁷¹ to R¹⁷³ is the substituent RA; and
the substituent RA is a substituted or unsubstituted alkyl group having 1 to 50 carbon atoms, a substituted or unsubstituted alkenyl group having 2 to 50 carbon atoms, a substituted or unsubstituted alkynyl group having 2 to 50 carbon atoms, a substituted or unsubstituted cycloalkyl group having 3 to 50 ring carbon atoms, a substituted or unsubstituted aryl group having 6 to 50 ring carbon atoms, or a substituted or unsubstituted monovalent heterocyclic group having 5 to 50 ring atoms.

2: The solid electrolyte composition according to claim 1, wherein R¹¹ to R¹³ in the formula (1) of the component (B) are independently a substituted or unsubstituted alkyl group having 1 to 50 carbon atoms, or a substituted or unsubstituted aryl group having 6 to 50 ring carbon atoms.

3: The solid electrolyte composition according to claim 1, wherein R¹¹ to R¹³ in the formula (1) of the component (B) are independently a substituted or unsubstituted alkyl group having 1 to 50 carbon atoms.

4: The solid electrolyte composition according to claim 1, wherein R²¹ to R²⁶ in the formula (2) of the component (B) are independently a substituted or unsubstituted alkyl group having 1 to 50 carbon atoms.

5: The solid electrolyte composition according to claim 1, wherein R³¹ to R³³ in the formula (3) of the component (B) are independently a substituted or unsubstituted alkyl group having 1 to 50 carbon atoms.

6: The solid electrolyte composition according to claim 1, wherein R⁵¹ in the formula (5) of the component (B) is a substituted or unsubstituted alkyl group having 1 to 50 carbon atoms.

7: The solid electrolyte composition according to claim 1, wherein R⁶¹ in the formula (6) of the component (B) is a substituted or unsubstituted alkenyl group having 2 to 50 carbon atoms.

8: The solid electrolyte composition according to claim 1, wherein R⁷¹ in the formula (7) of the component (B) is a substituted or unsubstituted alkenyl group having 2 to 50 carbon atoms.

9: The solid electrolyte composition according to claim 1, wherein R⁸¹ to R⁸³ in the formula (8) of the component (B) are independently a substituted or unsubstituted alkyl group having 1 to 50 carbon atoms.

10: The solid electrolyte composition according to claim 1, wherein R⁹¹ in the formula (9) of the component (B) is a substituted or unsubstituted alkyl group having 1 to 50 carbon atoms.

11: The solid electrolyte composition according to claim 1, wherein R¹⁰¹ to R¹⁰³ in the formula (10) of the component (B) are independently a substituted or unsubstituted alkyl group having 1 to 50 carbon atoms.

12: The solid electrolyte composition according to claim 1, wherein M1 in the formula (11) of the component (B) is silicon (Si) atom, titanium (Ti) atom, germanium (Ge) atom, zirconium (Zr) atom, tin (Sn) atom, hafnium (Hf) atom, or lead (Pb) atom.

13: The solid electrolyte composition according to claim 1, wherein R¹¹¹ to R¹¹⁴ in the formula (11) of the component (B) are independently a group represented by —O—RA.

14: The solid electrolyte composition according to claim 1, wherein R¹¹¹ to R¹¹⁴ in the formula (11) of the component (B) are independently a group represented by —O—RA, and RA is a substituted or unsubstituted alkyl group having 1 to 50 carbon atoms.

15: The solid electrolyte composition according to claim 1, wherein in the formula (11) of the component (B), some of R¹¹¹ to R¹¹⁴ are independently a group represented by —O—RA, and the other R¹¹¹ to R¹¹⁴ are independently a substituent RA.

16: The solid electrolyte composition according to claim 1, wherein in the formula (11) of the component (B), some of R¹¹¹ to R¹¹⁴ are independently a group represented by —O—RA, the other R¹¹¹ to R¹¹⁴ are independently a substituent RA, and RA is a substituted or unsubstituted alkyl group having 1 to 50 carbon atoms.

17: The solid electrolyte composition according to claim 1, wherein M2 in the formula (12) of the component (B) is boron (B) atom, aluminum (Al) atom, scandium (Sc) atom, gallium (Ga) atom, yttrium (Y) atom, indium (In) atom, or gadolinium (Gd) atom.

18: The solid electrolyte composition according to claim 1, wherein R¹²¹ to R¹²³ in the formula (12) of the component (B) are independently a group represented by —O—RA.

19: The solid electrolyte composition according to claim 1, wherein R¹²¹ to R¹²³ in the formula (12) of the component (B) are independently a group represented by —O—RA, and RA is a substituted or unsubstituted alkyl group having 1 to 50 carbon atoms.

20: The solid electrolyte composition according to claim 1, wherein the component (B) is one or more compounds selected from the compounds represented by the formulas (1), (3), (5), (8), (10), (11), (12) and (14) to (16).

21: The solid electrolyte composition according to claim 1, wherein the amount of the component (B) is 0.1 to 20% by mass based on the total amount of the component (A) and the component (B).

22: The solid electrolyte composition according to claim 1, wherein the component (B) is a compound comprising a group having a chain length of 4 or more carbon atoms.

23: The solid electrolyte composition according to claim 1, wherein the component (A) further comprises a halogen atom.

24: The solid electrolyte composition according to claim 1, wherein the component (A) comprises one or more elements selected from the group consisting of chlorine (Cl), bromine (Br) and iodine (I).

25: The solid electrolyte composition according to claim 1, wherein the component (A) comprises chlorine (Cl).

26: The solid electrolyte composition according to claim 1, wherein the component (A) comprises chlorine (Cl) and bromine (Br).

27: The solid electrolyte composition according to claim 1, wherein the component (A) has a crystalline structure.

28: The solid electrolyte composition according to claim 1, wherein the component (A) has argyrodite type crystalline structure.

29: The solid electrolyte composition according to claim 1, wherein the component (A) has a thio-LISICON Region II type crystalline structure.

30: The solid electrolyte composition according to claim 1, which further comprises (C) a solvent.

31: The solid electrolyte composition according to claim 1, which does not substantially include (C) a solvent.

32: The solid electrolyte composition according to claim 1, which further comprises (D) an electrode active material.

33: A solid electrolyte layer or an electrode mixture obtained from the solid electrolyte composition according to claim 1.

34: A lithium-ion battery comprising the solid electrolyte layer or the electrode mixture according to claim 33.

35: A lithium-ion battery comprising an electrode and a solid electrolyte layer, wherein at least one of the electrode and the solid electrolyte layer comprises (A) a sulfide solid electrolyte comprising lithium, phosphorus and sulfur, and (B) one or more compounds selected from compounds represented by the following formulas (1) to (17): 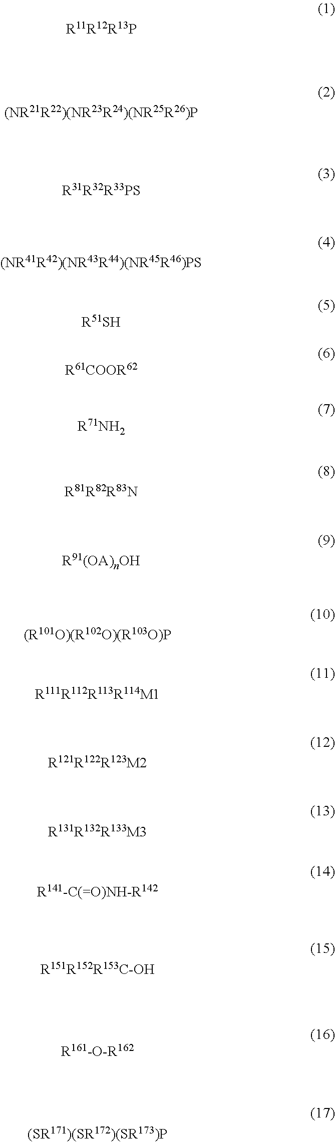
wherein in the formula (1), R¹¹ to R¹³ are independently a hydrogen atom or a substituent RA, and at least one of R¹¹ to R¹³ is the substituent RA;
in the formula (2), R²¹ to R²⁶ are independently a hydrogen atom or a substituent RA, and at least one of R²¹ to R²⁶ is the substituent RA;
in the formula (3), R³¹ to R³³ are independently a hydrogen atom or a substituent RA, and at least one of R³¹ to R³³ is the substituent RA;
in the formula (4), R⁴¹ to R⁴⁶ are independently a hydrogen atom or a substituent RA, and at least one of R⁴¹ to R⁴⁶ is the substituent RA;
in the formula (5), R⁵¹ is a substituent RA;
in the formula (6), R⁶¹ is a substituent RA, and R⁶² is a hydrogen atom or a substituent RA;
in the formula (7), R⁷¹ is a substituent RA;
in the formula (8), R⁸¹ to R⁸³ are independently a hydrogen atom or a substituent RA, and at least one of R⁸¹ to R⁸³ is the substituent RA;
in the formula (9), R⁹¹ is a substituent RA, and A is an alkylene group having 2 to 4 carbon atoms; n is 1 to 20;
in the formula (10), R¹⁰¹ to R¹⁰³ are independently a hydrogen atom or a substituent RA, and at least one of R¹⁰¹ to R¹⁰³ is the substituent RA;
in the formula (11), R¹¹¹ to R¹¹⁴ are independently a hydrogen atom, a substituent RA, or a group represented by —O—RA, and at least one of R¹¹¹ to R¹¹⁴ is the substituent RA or the group represented by —O—RA; M1 is a tetravalent atom;
in the formula (12), R¹²¹ to R¹²³ are independently a hydrogen atom, a substituent RA, or a group represented by —O—RA, and at least one of R¹²¹ to R¹²³ is the substituent RA or the group represented by —O—RA; M2 is a trivalent atom;
in the formula (13), R¹³¹ to R¹³³ are independently a hydrogen atom, a substituent RA, or a group represented by —O—RA, and at least one of R¹³¹ to R¹³³ is the substituent RA or the group represented by —O—RA; M3 is a trivalent organic group including a triazine skeleton;
in the formula (14), R¹⁴¹ and R¹⁴² are independently a hydrogen atom, a substituent RA, or a group represented by —O—RA, and at least one of R¹⁴¹ and R¹⁴² is the substituent RA or the group represented by —O—RA;
in the formula (15), R¹⁵¹ to R¹⁵³ are independently a hydrogen atom, a substituent RA, or a group represented by —O—RA, and at least one of R¹⁵¹ to R¹⁵³ is the substituent RA or the group represented by —O—RA;
in the formula (16), R¹⁶¹ and R¹⁶² are independently a substituent RA;
in the formula (17), R¹⁷¹ to R¹⁷³ are independently a hydrogen atom or a substituent RA, and at least one of R¹⁷¹ to R¹⁷³ is the substituent RA; and
the substituent RA is a substituted or unsubstituted alkyl group having 1 to 50 carbon atoms, a substituted or unsubstituted alkenyl group having 2 to 50 carbon atoms, a substituted or unsubstituted alkynyl group having 2 to 50 carbon atoms, a substituted or unsubstituted cycloalkyl group having 3 to 50 ring carbon atoms, a substituted or unsubstituted aryl group having 6 to 50 ring carbon atoms, or a substituted or unsubstituted monovalent heterocyclic group having 5 to 50 ring atoms.
